(19) United States
(12) Patent Application Publication
(10) Pub. No.: US 2026/0000566 A1
(43) Pub. Date: Jan. 1, 2026

(54) APPARATUS FOR STAIRWAY FALL PREVENTION AND METHOD THEREOF

(71) Applicant: Robert Hall, Canton, OH (US)

(72) Inventor: Robert Hall, Canton, OH (US)

(21) Appl. No.: 19/249,493

(22) Filed: Jun. 25, 2025

Related U.S. Application Data
(60) Provisional application No. 63/664,506, filed on Jun. 26, 2024.

(51) Int. Cl. A61H 3/00

(52) U.S. Cl. CPC A61H 3/008; A61H 2003/001

(57) ABSTRACT

The present disclosure provides an apparatus, method and kit to provide a safe traversal of stairs in a home environment. The system has subsystems for mounting and trolley apparatus. The system also has subsystems for de-slacking a tether along with harness configurations. The kit provides a retrofittable de-slacking, tether, and harness configuration for safety systems of other configurations. The present disclosure further provides interchangeable features of the various subsystems. The mounting and trolley subsystem may be mounted to a wall or a ceiling depending on the needs of the user.

### CROSS REFERENCE TO RELATED APPLICATIONS

This application claims the benefit of U.S. Provisional Patent Application Ser. No. 63/664,506, filed Jun. 26, 2024; the entire specification of which is incorporated herein by reference.

### TECHNICAL FIELD

This disclosure relates generally to home safety for traversing stairs. More particularly, this disclosure related to an apparatus and method for preventing falls of a user who may be elderly or impaired while walking up or down a flight of stairs in a home environment.

### BACKGROUND ART

FIG. 1 is a diagrammatic view of PRIOR ART that provides a general view of a home environment. Homes that have multiple floors often have stairs 102. It is to be appreciated that stairs 102 may come in a large variety of configurations, and some older homes may have a narrow stairwell that pre-date modern building codes. In most traditional homes, local legal building codes may only require a single handrail 104, thus most stairs 102 will have at least one handrail 104, while only a few may have two. In most environments 100, ceiling 106A may be parallel to the angle or slope of stairs 102, and in other environments 100, ceiling 106B may be substantially horizontal or flat. It is to be appreciated that in most homes ceiling 106A or 106B may not be constructed sufficiently to bear the weight of I-beam mechanisms or motorized, clinical grade safety systems. It is also to be appreciated that construction concerns for length of such items as an I-beam or other mechanism that spans a full coverage of a flight of stairs may not be practicable for a home environment. Further, some safety solutions, such as motorized chairs may not be amenable to older homes with narrow stairwells.

Stairs 102 may provide a difficulty for the elderly or disabled, herein user 108, especially those living alone or without assistance. Dexterity may be compromised, and traversing stairs 102 may provoke apprehension and present a safety hazard. U.S. Pat. No. 11,622,907 discusses concerns and provides a solution of a complex and weighty suspension system. US Patent Publication 2017/0112705 A1 further discusses benefits of staircase gait system that not only prevents a patient (elderly or otherwise) from falling down a staircase in a rehabilitation setting but also provides a clinical environment for therapy sessions. Drawbacks to both of these solutions include weight and environmental support limitations that are often present in homes. These limitations provide opportunities for improved apparatus and methods to deal with the particular home environment.

### SUMMARY OF THE INVENTION

In one aspect, an exemplary embodiment of the present disclosure may provide a system for safely traversing a set of steps, or stairs, in a home environment comprising a mount and trolley subsystem, and a de-slack and harness subsystem.

In another aspect, an exemplary embodiment of the present disclosure may provide a retrofit kit for safely traversing a set of steps, or stairs, in a home environment comprising a de-slack and harness system.

In another aspect, an exemplary embodiment of the present disclosure may provide an apparatus for safely traversing a set of steps, or stairs, in a home environment comprising a mount and trolley system. The mount and trolley system may be modular for ease of construction in a home environment. Home environments may include older homes that have stairways that would not pass modern building codes.

In another aspect, exemplary embodiments of the present disclosure may provide harness subsystems of “L” profile (or half) and “U” profile (or full) versions. These versions may provide for ease of manufacture with girth and back and/or front support portions being contiguous, and left and right side portions mirroring each other.

In yet another aspect, an embodiment of the present disclosure may provide a system for assisting the traversal of stairs in a residential environment, the system comprising: a mount that is connected to at least one of a ceiling and a vertical wall in the residential environment; a rail that is connected to the mount; a trolley operably connected to the rail, wherein the trolly moves along the rail in response to stair traversing movement, and wherein the trolley comprises a brake; a tether extending downward from the trolley; a harness connected to the tether, wherein the harness is donned during the stair traversing movement; wherein the brake is activated in response a force exerted on the tether that exceeds a maximum threshold and corresponds to a user falling when the harness is donned; and a de-slack subsystem operably connected to the tether to remove slack in the tether during the stair traversing movement.

This example embodiment or another example embodiment may provide that the de-slack subsystem comprises at least one reel that releases and retracts the tether. This example embodiment or another example embodiment may provide that the de-slack subsystem further comprises two reels located along the tether between the harness and the trolley, wherein at least one of the two reels releases and retracts a portion of the tether. This example embodiment or another example embodiment may provide that the de-slack subsystem retracts the tether when the user traverses the stairs towards a top end of the stairs, and wherein the de-slack system releases the tether when the user traverses the stairs towards a bottom end of the stairs.

This example embodiment or another example embodiment may provide that the rail is composed of multiple rails sections connected end-to-end, wherein each rail section is four feet or less in length, which is adapted to facilitate ease of installation in the residential environment.

This example embodiment or another example embodiment may provide that the mount comprises an L-shaped member having a vertical first leg and a horizontal second leg, wherein the vertical first leg is fixedly connected to the vertical wall in the residential environment below the ceiling. This example embodiment or another example embodiment may provide that the mount further comprises a terminal free end of the horizontal second leg the L-shaped member, wherein the rail is connected to the terminal free end of the horizontal second leg. This example embodiment or another example embodiment may provide that the mount further comprises a cross brace extending between the vertical first leg and the horizontal second leg.

This example embodiment or another example embodiment may provide that the harness comprises a connector located near the center of the harness, wherein the connector is a hook or loop that is connected to a connection point on the tether. This example embodiment or another example embodiment may provide that the harness comprises a first panel, a second panel, a third panel, a fourth panel, and a fifth panel, wherein the first panel, second panel, third panel, fourth panel, and fifth panel are connected, respectively, by spacer elements. This example embodiment or another example embodiment may further includes a belt on the harness that extends from a first connector coupled to a first end of the belt to a second connector coupled to a second end of the belt; wherein the belt extends across first panel, the second panel, the third panel, the fourth panel, and the fifth panel and the respective spacer elements, and wherein the belt is adjustable to vary a circumference of the harness when the first connector and the second connector are connected together.

This example embodiment or another example embodiment may further include a first portion of the tether that is attached to the trolley; a second portion of the tether is free from the trolley; and a handle at the second portion of the tether, wherein the handle is configured to be grasped by the user while traversing the stairs.

This example embodiment or another example embodiment may further include wheels on the trolley that remain in a stationary first position until a sufficient force is applied to the harness or tether that exceeds a minimum threshold indicative of the user having donned the harness to thereby prevent trolley movement when the system is not in use, and wherein the wheels of the trolley are permitted to roll when the force is applied exceeds the minimum threshold to thereby enable the trolley to move to a second position along the rail.

In yet another aspect, an example embodiment of the present disclosure may provide a method of traversing stairs in a residential environment comprising: donning a harness connected to a tether that extends downward from a trolley that is moveable along a rail mounted to one of a wall and a ceiling above stairs in a residential environment; traversing the stairs; retracting slack in the tether with a de-slack subsystem comprising at least one reel coupled to the tether in response traversing the stairs; and applying a brake to stop movement of the trolley in response to an exerted force that exceeds a maximum threshold, wherein the maximum threshold is associated with a user having fallen while traversing the stairs.

This example embodiment or another example embodiment may further include enabling the trolley to move along the rail in response to donning the harness by applying a force that exceeds a minimum threshold, wherein the trolley remains stationary until the force exceeds the minimum threshold.

This example embodiment or another example embodiment may further include lengthening the tether of the de-slack system between the harness and the at least one reel by unspooling the reel when traversing down the stairs.

This example embodiment or another example embodiment may further include shortening the tether of the de-slack system between the harness and the at least one reel by unspooling the reel when traversing up the stairs.

This example embodiment or another example embodiment may further include holding on to a handle located at a free end of the tether while traversing the stairs, wherein the handle is free from the harness; and using the handle as support while traversing the stairs.

This example embodiment or another example embodiment may further include moving the trolley along the rail that is connected to a mount comprised of an L-shaped member, wherein the L-shaped member includes a vertical first leg and a horizontal second leg, wherein the vertical first leg is fixedly connected to the vertical wall in the residential environment below the ceiling.

This example embodiment or another example embodiment may further include moving the trolley along the rail that is composed of multiple rail sections connected end-to-end, wherein each rail section is four feet or less in length, which is adapted to facilitate ease of installation in the residential environment.

### BRIEF DESCRIPTION OF THE DRAWINGS

Sample embodiments of the present disclosure are set forth in the following description, are shown in the drawings and are particularly and distinctly pointed out and set forth in the appended claims. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a diagrammatic view of PRIOR ART that provides a general view of a home environment.

FIG. 2 is a diagrammatic view of a system comprising a mount and trolley subsystem, a de-slack tether subsystem and a harness subsystem of embodiments, highlighting the ability to put various subsystems together.

FIG. 3A is a transverse cross section view taken along line 3A-3A in FIG. 2 depicting an embodiment of a mount and trolley subsystem.

FIG. 3B is a longitudinal section view taken along line 3B-3B in FIG. 3A depicting the mount and trolley subsystem.

FIG. 4 is a transverse cross section view taken along line 3A-3A in FIG. 2 depicting another embodiment of a mount and trolley subsystem.

FIG. 5 is a transverse cross section view taken along line 3A-3A in FIG. 2 depicting yet another embodiment of a mount and trolley subsystem.

FIG. 6 is a perspective view of a de-slack subsystem embodiment.

FIG. 7 is a perspective view of another de-slack subsystem embodiment.

FIG. 8 is a perspective view of another de-slack subsystem embodiment, which is shown in two different positions.

FIG. 9A is an isometric view of a first embodiment of a harness subsystem embodiment in a closed position.

FIG. 9B is an isometric view of the first embodiment of the harness subsystem embodiment in the open position.

FIG. 9C is a side elevation view of the first embodiment of the harness subsystem embodiment.

FIG. 10A is an isometric view of a second embodiment of a harness subsystem embodiment in a closed position.

FIG. 10B is a side elevation view of the second embodiment of the harness subsystem embodiment in an open position.

FIG. 11A is an isometric view of the first embodiment of the harness subsystem embodiment illustrating another aspect of the subsystem.

FIG. 11B is an isometric view of the second embodiment of the harness subsystem embodiment illustrating another aspect of the subsystem.

FIG. 12 is a diagrammatic view of one example use embodiment of a system with selected aspects.

FIG. 13 is a diagrammatic view of another use embodiment of a system with selected aspects.

FIG. 14 is a diagrammatic view of another use embodiment of a system with selected aspects.

FIG. 15A is a diagrammatic view of a second embodiment of a system comprising a mount and trolley subsystem, a de-slack tether subsystem and a harness subsystem of embodiments, highlighting the ability to put various subsystems together.

FIG. 15B is a transverse cross section view taken along line 15B-15B in FIG. 15A depicting an embodiment of a mount and trolley subsystem.

FIG. 16 is a top elevation view of a second embodiment of a harness system.

FIG. 17 is an interior elevation view of the second embodiment of the harness system.

FIG. 18 is an exterior elevation view of the second embodiment of the harness system.

FIG. 19 is an operational front elevation view of a user wearing the second embodiment of the harness system.

FIG. 20 is an operational side view of the user wearing the second embodiment of the harness system.

FIG. 21 is an operational rear elevation view of the user wearing the second embodiment of the harness system.

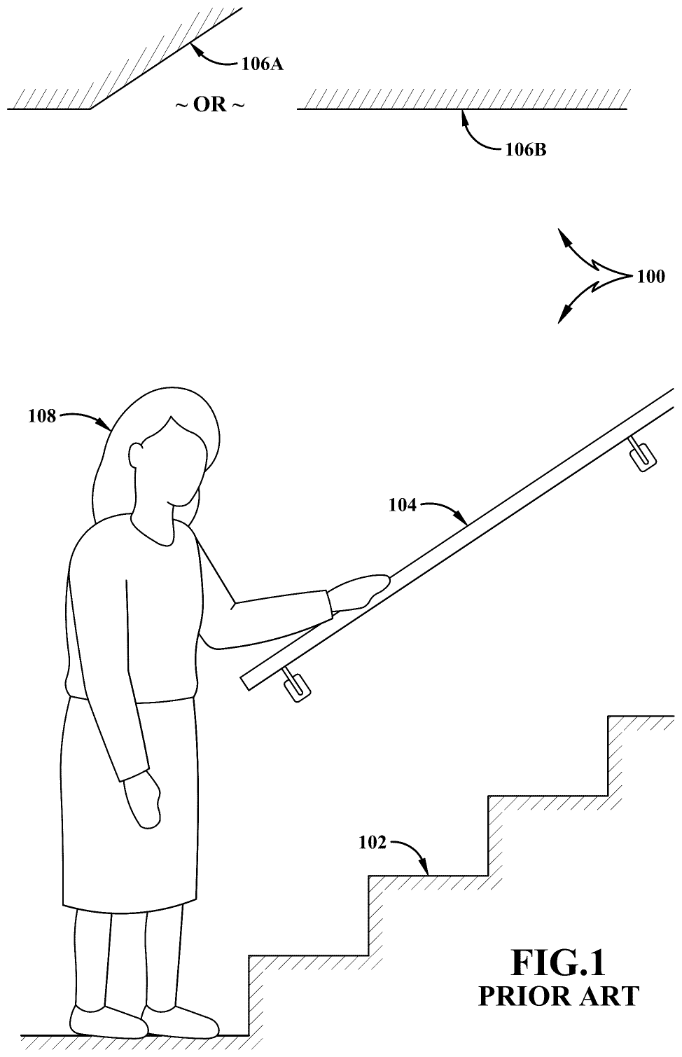

Similar numbers refer to similar parts throughout the drawings.

### DETAILED DESCRIPTION

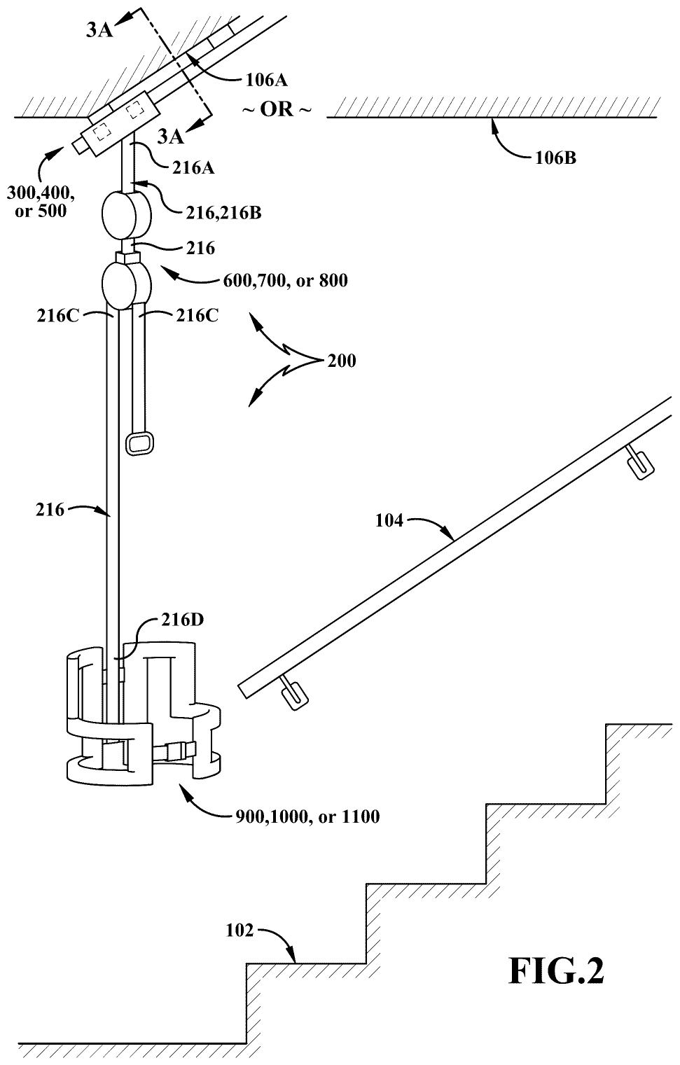

A system and methods of operation thereof is depicted in the present disclosure and throughout FIGS. 2-21. The system in its various embodiments may provide safety to elderly or otherwise infirm users in a home setting for safely traversing a flight of stairs, averting falls and reducing the apprehension of falls.

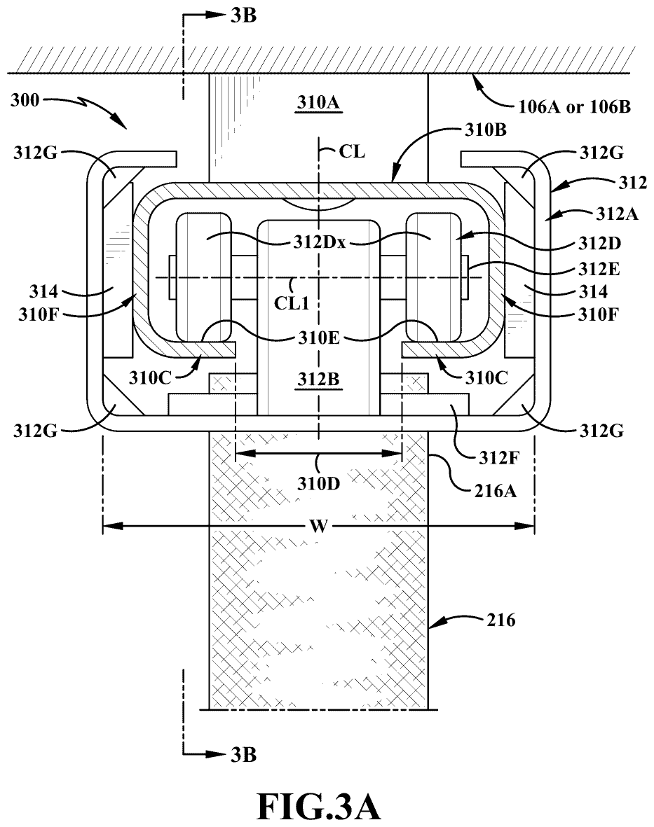

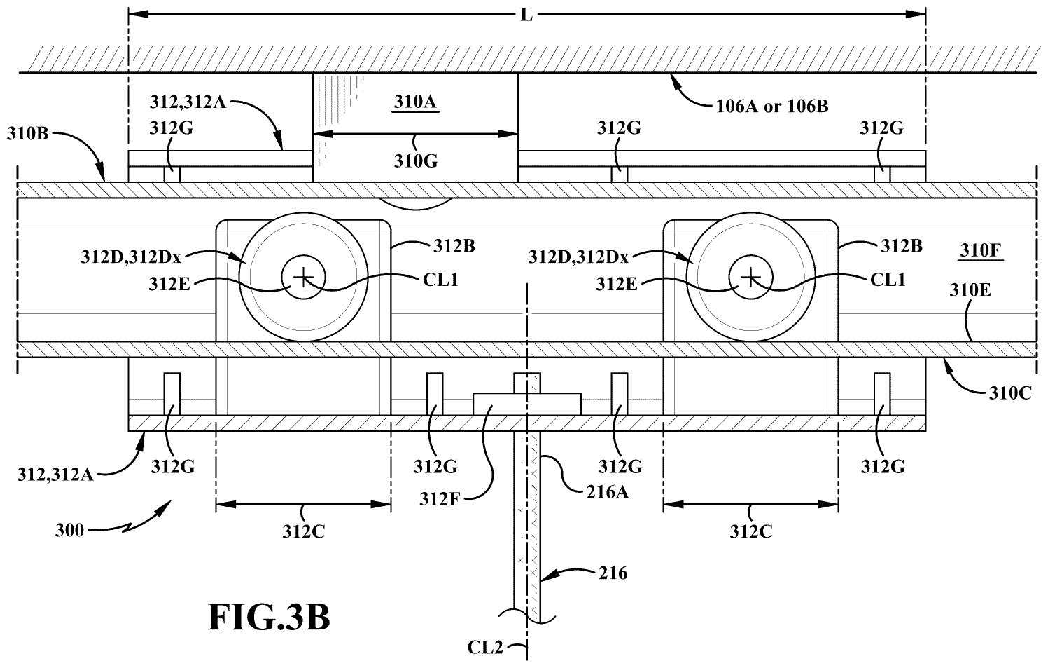

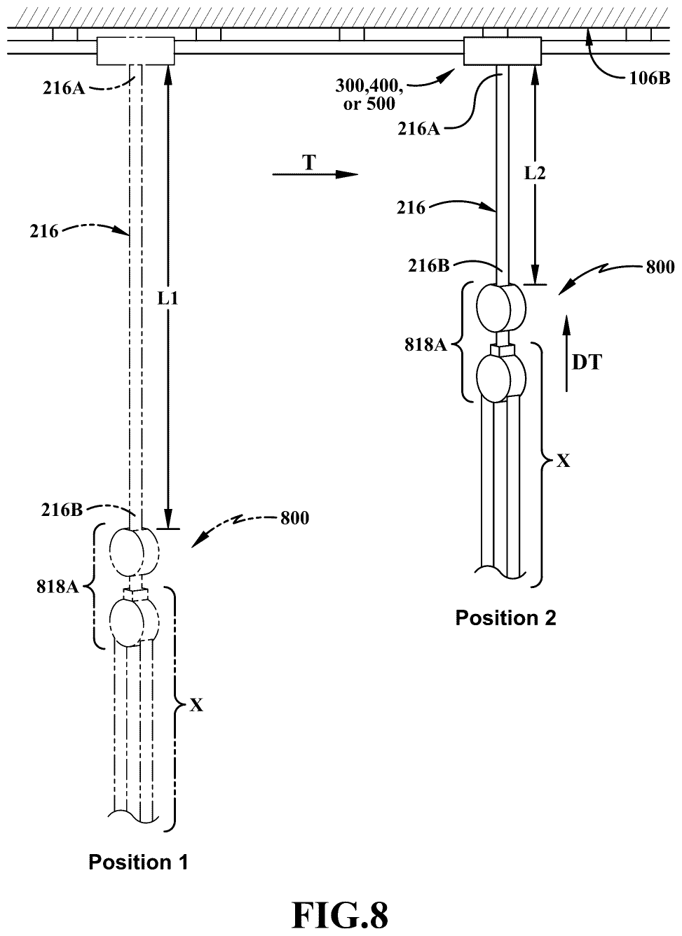

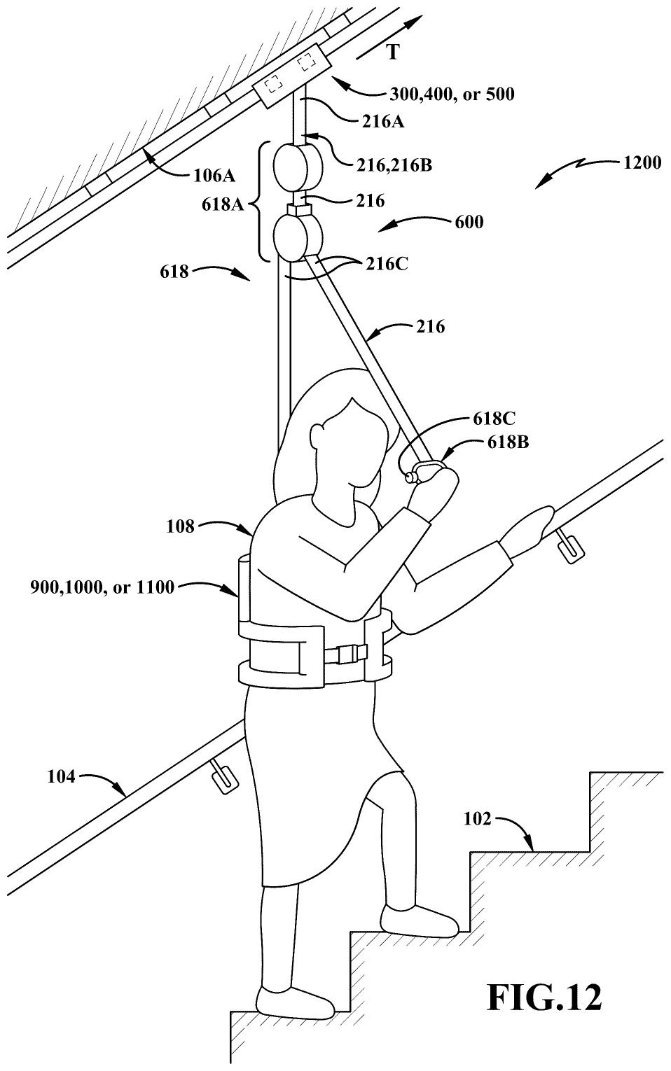

Referring now to FIG. 2, a diagrammatic view of an exemplary system 200 is shown. The view comprises a mount and trolley subsystem 300, 400, or 500, a de-slack tether subsystem 600, 700, or 800, and a harness subsystem 900, 1000, or 1100, of embodiments and highlights the ability to put various subsystems together. In a home environment, a set of steps or stairs 102 may have zero, one or two handrails 104. Above stairs 102, there may be a ceiling 106A that is substantially parallel to the angle or slope of stairs 102. Alternatively, there may be a ceiling 106B that is substantially horizontal or flat above stairs 102 (see also FIG. 8). Component subsystems of system 200 will be covered in greater detail in relation to discussions of FIG. 3A through FIG. 11B. Use embodiments (or use cases) of system 200 will be covered in greater detail in relation to discussions of FIG. 12 through FIG. 14.

With continued reference to FIG. 2, subsystem mount and trolley 300, 400, or 500 (which shall be discussed in more detail herein), may be configured in a home as part of exemplary system 200. It is to be appreciated that the mounting to the ceiling 106A or 106B is attached by screw, rivet, adhesive or otherwise suitable engageable device.

Attached to the mount and trolley subsystem 300, 400, or 500 is tether 216. It is to be appreciated that tether 216 may form a plurality of sections and be attached to a plurality of items as discussed herein. Tether 216 may have an end or upper portion 216A. Tether end 216A will be attached to trolley 312, 412, or 512 as discussed herein. Tether 216 will have a second operative connection end 216B connected with de-slack subsystem 600, 700, or 800, as will be discussed herein. De-slack subsystems may comprise one or two reels (or other “slack take up” mechanisms that may not necessarily be in the form of a reel) in various embodiments. In two-reel embodiments, the reels may have a portion tether 216 affixing the reels to each other. For example, functional elements of both upper reel and lower reel of reel 618A can be co-located in a single larger reel, with side by side, top over bottom, or the like configurations.

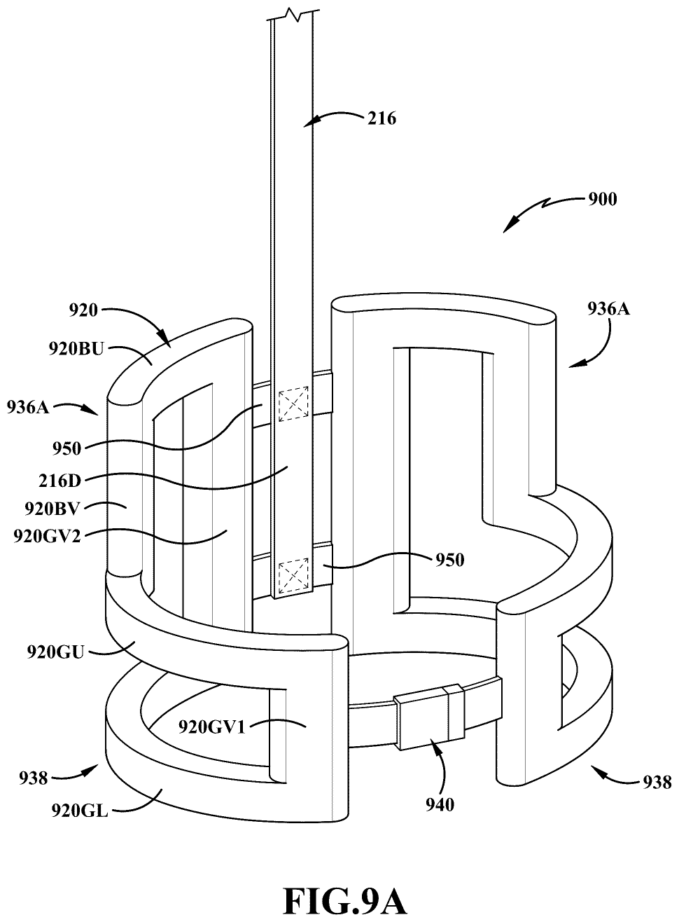

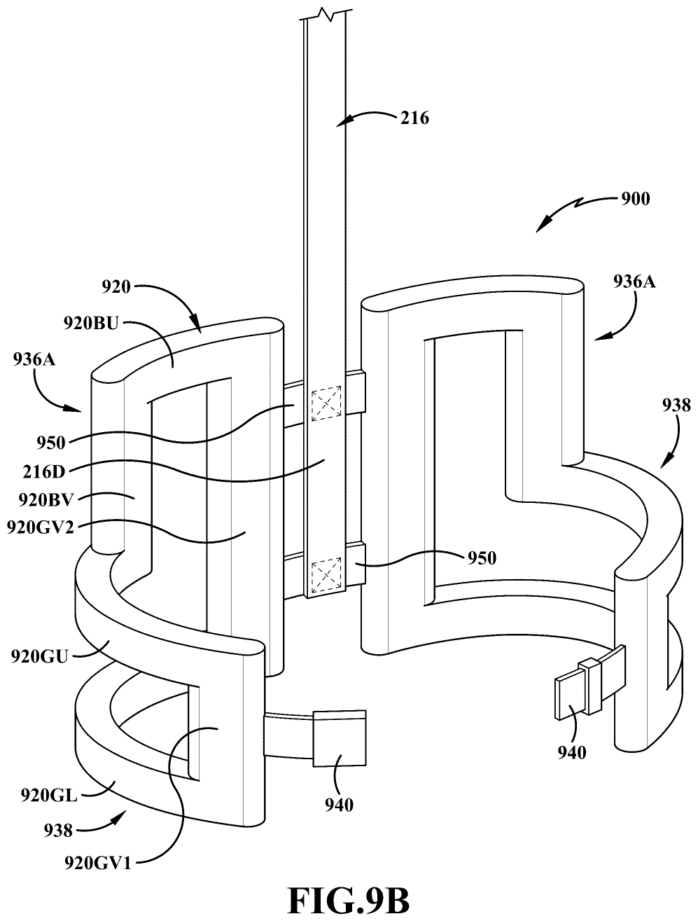

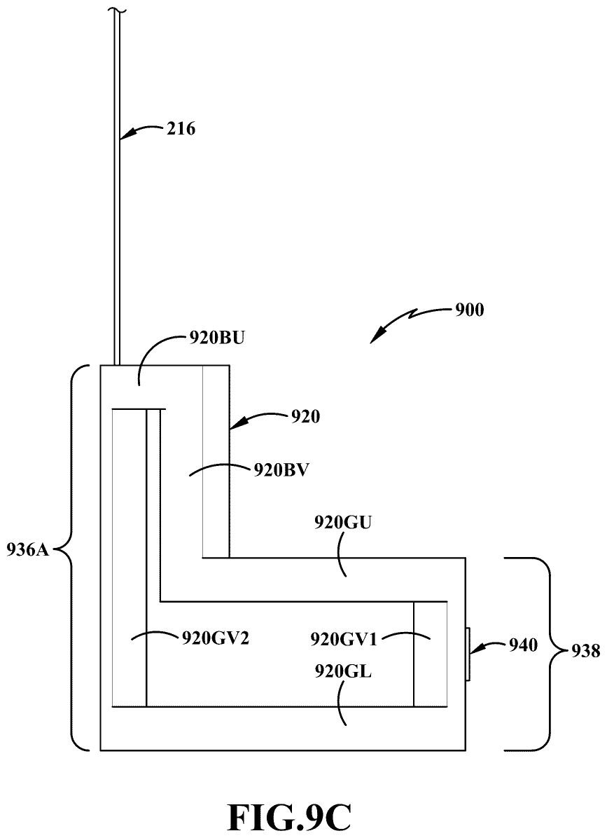

Further shown in FIG. 2 is harness subsystem 900, 1000, or 1100. Harness subsystem 900, 1000, or 1100, in various embodiments that will be discussed in greater detail in relation to FIG. 9A through FIG. 11B, is attached at the lower end of de-slack subsystem 600, 700, or 800 by way of a separate portion of tether 216. As noted earlier, tether 216 may be comprised of one or more separate sections or portions. The lower end attachment to de-slack subsystem 600, 700, or 800 may be an upper separate portion of tether 216C. At the lower end of the separate portion of tether 216, which attaches to harness subsystem 900, 1000, or 1100, may be a lower separate portion of tether 216D. It is to be appreciated that attachments of tether 216 to the various items may be by any known method, and may include without limitation by screw, sewn connection, rivet, adhesive or otherwise suitable engageable device.

It is to be appreciated that the embodiments disclosed herein in relation to de-slack and harness subsystems may be serviceable as a separate retrofit kit for either prior installations of embodiments of the mount and trolley subsystems as disclosed herein (or other systems) for home use, or in other environments with other mounted safety systems, such as for example, the systems disclosed in U.S. Pat. No. 11,622,907 to Lojoie or to systems disclosed in US Patent Publication 2017/0112705 to Hornby et al., or the like.

In various embodiments and in general, mount and trolley subsystems serve the function of mounting simple and comparatively light weight structural attachments to a ceiling in a home above stairs with a slidable/rolling trolley and brake mechanisms. It is contemplated that the mount and trolley systems may be modular, with pre-determined lengths (for example, lengths of approximately four feet or less), that may be assembled in a slidingly or abutting manner to encompass a full length of a set of steps, or stairs. Other embodiments (not shown) may have male and female ends to ease construction in a home environment. Mounts or mounting elements of a mount and trolley subsystem may be mounted as may be known in the art to studs in the ceiling for structural support. Trolley elements generally are engagedly connected to the embodiments of rails that are affixed to mounts, and the trolley embodiments generally have brake elements. In certain embodiments, the brake systems contain elements that provide one or more slidingly connections between embodiments of the rails and embodiments of the trolleys. In other embodiments, it is contemplated that the elements that provide the one or more slidingly connections are part of embodiments to trolleys, and other brake systems (not shown) may be utilized.

In general, for certain embodiments in which brake systems contain elements that provide one or more slidingly connections, the element or elements that provides this slidingly connection also provides the braking force. For this element or elements, friction may be considered to be a function of weight (W1) loaded on the element by way of the weight of the trolley (of a mount and trolley subsystem), and weight of a de-slack and harness subsystems, given by the formula:

W1=Friction Coefficient*Contact Factor*Subsystems weight(portion trolley+de-slack and harness) FORMULA W1:

and is configured such that this weight W1 provides a minimum threshold to prevent the trolley, and de-slack and harness subsystem from sliding on their own. The weight of the mount and rail elements are not included. Any additional force provides that the slidingly connection is engaged, and the trolley portion of a mount and trolley subsystem will slide (or permit to roll in certain embodiments) in a direction that a user in a harness of a de-slack and harness subsystem is moving. The slidingly connection will remain in this mode up to another threshold WU, given by the formula:

WU=Friction Coefficient*Contact Factor*((Safety Factor*User Weight)+Subsystems weight(portion trolley+de-slack and harness)) FORMULA WU:

It is to be appreciated that WU may be determined for a range with a minimum user weight setting a low band for WU and a maximum user weight setting a high band. It is further to be appreciated that a safety factor may be chosen to suit industry or governmental requirements. Contact factor may be determined by at least surface area of sliding members in contact with rail portions of a mount and trolley subsystem as discussed herein in various embodiments.

Any force applied greater than the maximum threshold WU provides enough force to activate the brake and stop the trolley portion of a mount and trolley subsystem from traversing along the path of a rail portion of the mount and trolley subsystem. For example, a user 108 falling while traversing stairs 102, would be sufficient force to brake a system, such as system 200, and prevent user 108 from landing awkwardly or falling farther down stairs 102. Instead, user 108 will be only slightly lowered from a normal stepping position, and thus able to recontrol themselves, and plant themselves firmly back on stairs 102. Thus, with control re-established, the force from the weight threshold WU is released from the brake function, and the trolley portion of a mount and trolley subsystem, is once again within a force range of being slidingly connected, allowing user 108 to continue traversing stairs 102. In this manner, user 108 merely needs to traverse stairs 102 with a minimal force to overcome W1 and the trolley portion of a mount and trolley subsystem will slide (or permit to roll) along. When user 108 has completed the traverse, removing themselves from a harness component of the harness subsystem reduces the force to the threshold W1, preventing sliding/rolling. In this manner, when user 108 has ascended a set of steps, or stairs 102, completes any activity at that level and desires to return to the bottom of stairs 102, the system 200 is available, and components would not have slid/rolled down the rail portion of the mount and trolley subsystem to the bottom of stairs 102.

Turning now to FIG. 3A, a transverse cross section view taken along line 3A-3A in FIG. 2 depicting an embodiment of a mount and trolley subsystem 300 is shown. Mount 310A is shown affixed to ceiling 106A or 106B. It is to be appreciated that mount 310A may be attached by screw, rivet, adhesive or otherwise suitable engageable device.

Affixed to mount 310A is rail 310B, and rail 310B is configured in this embodiment to be in the shape of an open “C” with short legs 310C and an opening 310D defined by short legs 310C of the “C” facing downward. It is to be appreciated that centerline CL bisects the mount and trolley subsystem into mirror left and right portions in this view. The substantially horizontal portion of the inner (top) short legs is denoted as 310E. Rail 310B has outer portions 310F of the left and right outer “C” (the outer top and bottom of the “C” shape). It is to be appreciated that mount and trolley subsystem 300 may be comprised of a plurality of mounts 310A and modular rails 310B. Modular rails 310B are contemplated to be available in a number of predetermined lengths, with suitable connecting mechanisms as may be known in the art (not shown). It is contemplated that end-to-end connections may be slidably connected or male/female connected or able to be connected in a suitable manner. Given that the shown embodiment is a residential application, and not a commercial application, it is envisioned that the length of each of modular rails 310B is about four feet or less.

In this embodiment, trolley 312 is configured to have a trolley body 312A in the shape of an open “C” facing upward. Trolley body 312A has an inner width W and a centerline CL to that width W. Attached vertically on the inside of the “C” at centerline CL of inner width W of trolley body 312A is inner support 312B. Turning briefly to FIG. 3B, inner support 312B is portrayed in this embodiment as having a length 312C less than the length L of trolley body 312A. It is contemplated that for other embodiments, both length L of trolley body 312A and length 312C of inner support 312B may differ and may be chosen for design considerations. A plurality of inner supports 312B may be attached to trolley body 312A. In the embodiment shown, that plurality is two. For each inner support 312B, a wheel set 312D, mounted on wheel set axle 312E, places a plurality of wheels 312Dx equidistant from centerline “CL2” of the length L of trolley body 312.

Returning to FIG. 3A, in this embodiment, left and right wheels 312Dx are positioned on the inner, lower portions 310E of rail 310B. This surface provides a rolling connection for the wheels 312Dx of trolley 312. Trolley 312 is also generally configured to provide an attachment for tether 216A as attachment 312F. Trolley 312 may be further configured to have sliding member 314 in sliding contact with outer portions 310F of rail 310B. Sliding member 314 may contain friction reducing compounds that define all or a portion of a low friction interface operative to permit (or not permit) wheels 312Dx to roll on short legs 310C. These compounds may include, but are not limited to, ultra-high molecular weight (UHMW) polyethylene tape, polytetraflouoroethylene (PTFE) tape, or other films, extruded films, skived film or foam type coatings. As used herein, friction reducing compounds and low friction interface refers to surfaces or components having static and/or kinetic a coefficient of friction less than 0.2.

As discussed herein, the assembly of system subassemblies provides the lower threshold force so that portions of the mount and trolley subsystems, the de-slack subsystem and the harness subsystem will not slide/roll due to their own weight, while permitting a slidingly connection with minimal additional force up to the upper threshold force as discussed herein. It is to be appreciated that a band of force values between the lower threshold value and the upper threshold value permit wheels 312Dx to roll and trolley 312 to move. It is to be appreciated that trolley body 312A may be structurally reinforced with a plurality of reinforcements 312G.

Turning now to FIG. 3B, the longitudinal section view taken along line 3B-3B in FIG. 3A depicting the mount and trolley subsystem provides a view highlighting two trolley wheelsets 312D providing that the plurality of wheels 312Dx is four for this embodiment. Also visible is mount 310A that affixes rail 310B to ceiling 106A or 106B. It is to be appreciated that for any embodiments of mount subsystems, the mount elements 310A or modular rails 310B may be modular, with a length of individual modular sections being less than stairs 102 for ease of assembly as may be known in the art. Mount length 310G is substantially shorter than rail length (not shown, modular). It is to be appreciated that while a length of a single module of a mount and trolley subsystem is shown, modules may be repeated to make up the desired coverage of the stairs 102. Modular configurations may be in lengths of one, two, three or more feet. It is contemplated that an exemplary length would be four feet. Modular configurations may entail male and female ends of rails (not shown). Other mating configurations are also contemplated, such as for example slide connectors (not shown). Other connections as are known in the art may also be contemplated.

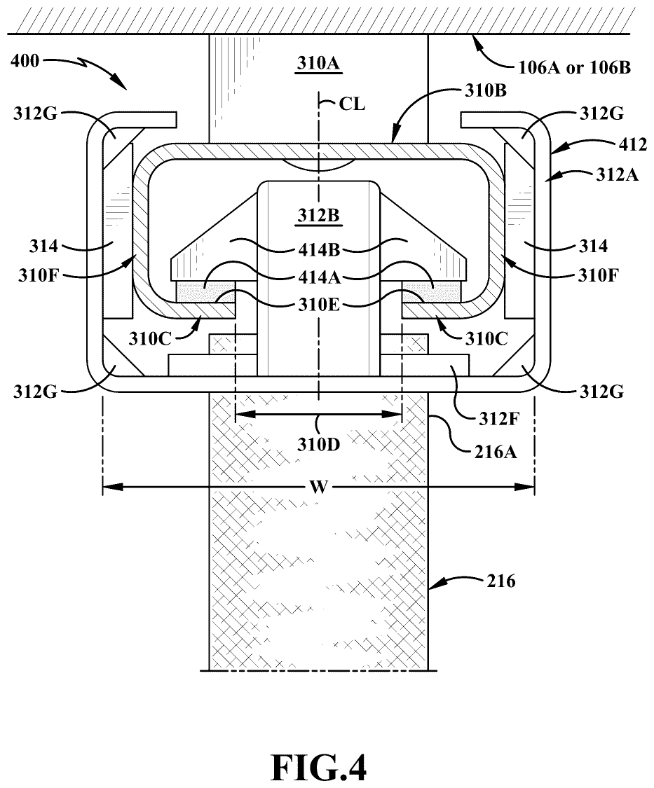

Turning now to FIG. 4, a transverse cross section view taken along line 3A-3A in FIG. 2 depicting another embodiment of a mount and trolley subsystem 400 is shown. With many items similar to the prior embodiment, mount 310A is shown affixed to ceiling 106A or 106B. It is to be appreciated that mount 310A is attached by screw, rivet, adhesive or otherwise suitable engageable device.

Affixed to mount 310A is rail 310B, and rail 310B is configured in this embodiment to be in the shape of an open “C” with short legs 310C and an opening 310D defined by short legs 310C of the “C” facing downward. It is to be appreciated that centerline CL bisects the mount and trolley subsystem into mirror left and right portions in this view. The substantially horizontal portion of the inner (top) short legs is denoted as 310E. Rail 310B has outer portions 310F of the left and right outer “C” (the outer top and bottom of the “C” shape). It is to be appreciated that mount and trolley subsystem 300 may be comprised of a plurality of mounts 310A and modular rails 310B. Modular rails 310B are contemplated to be available in a number of predetermined lengths, with suitable connecting mechanisms as may be known in the art (not shown). It is contemplated that end-to-end connections may be slidably connected or male/female connected or able to be connected in a suitable manner. Given that the shown embodiment is a residential application, and not a commercial application, it is envisioned that the length of each of modular rails 310B is about four feet or less.

In this embodiment, trolley 412 is configured to have a trolley body 312A in the shape of an open “C” facing upward. Trolley body 312A has an inner width W and a centerline CL to that width. Attached vertically on the inside of the “C” at centerline CL of inner width W of trolley body 312A is inner support 312B. A plurality of inner support 312B may be attached to trolley body 312A. For each inner support 312B, a pair of slides 414A and slide supports 414B are replaced of trolley wheel set 312D, trolley wheelset axle 312E and wheels 312Dx from the previous embodiment (i.e., subsystem 300). In this embodiment, left and right slides 414A and slide supports 414B are positioned on trolley inner support 312B and create a mating surface with the inner, lower portions 310E of rail 310B. This mating surface provides a portion of a sliding connection for slide 414A of trolley 412. Trolley 412 is also generally configured to provide an attachment for tether 216A as attachment 312F. Trolley 412 may be further configured to have sliding member 314 in sliding contact with outer portions 310F of rail 310B. Sliding member 314 and slide 414A may contain friction reducing compounds that define all or a portion of a low friction interface operative to permit (or not permit) trolley 412 to slide on short legs 310C. These compounds may include, but are not limited to, ultra-high molecular weight (UHMW) polyethylene tape, polytetraflouoroethylene (PTFE) tape, or other films, extruded films, skived film or foam type coatings. As used herein, friction reducing compounds and low friction interface refers to surfaces or components having static and/or kinetic a coefficient of friction less than 0.2. It is to be appreciated that in this embodiment, contacting surface area of sliding member 314 may vary from other embodiments in order to account for contacting surface area of slide 414A (and account for different force vectors) to provide operation similar to thresholds W1 and WU as discussed herein.

As discussed herein, the assembly of system subassemblies provides the lower threshold force so that portions of the mount and trolley subsystems, the de-slack subsystem and the harness subsystem will not slide/roll due to their own weight, while permitting a slidingly connection with minimal additional force up to the upper threshold force as discussed herein. It is to be appreciated that a band of force values between the lower threshold value and the upper threshold value permit trolley 412 to slide and move. It is to be appreciated that trolley body 312A may be structurally reinforced with a plurality of reinforcements 312G. It is also to be appreciated that in this embodiment, the trolley 412 may be differently sized than trolley 312 for the same mount 310A and the same rail 310B. It is also to be appreciated that a smaller size may be provided and still have the same thresholds as trolley 312 due to increased connection areas (and related force vectors) related to sliding members 414 and/or 314.

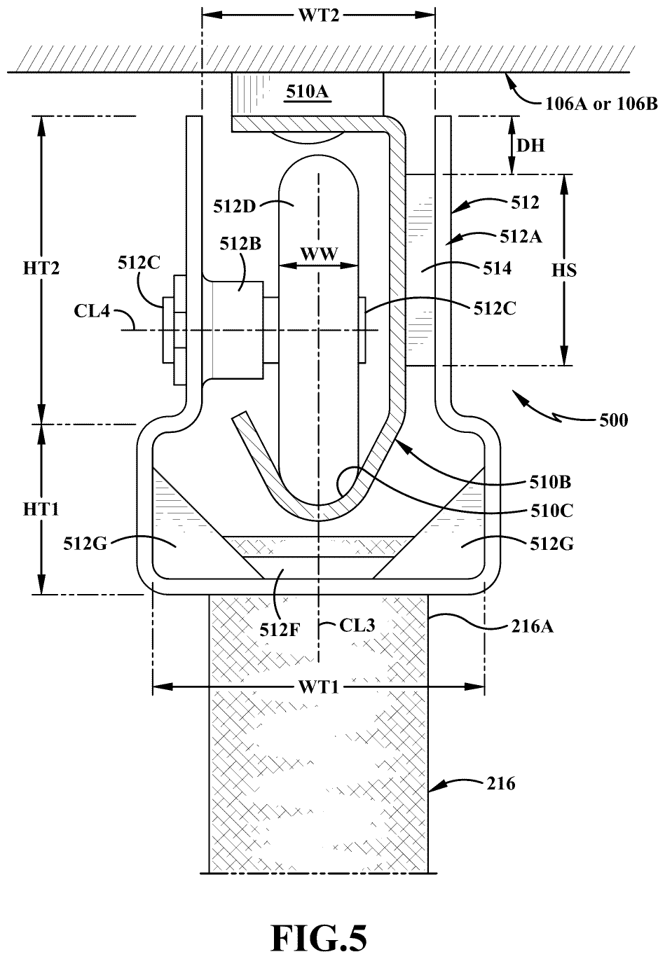

Turning now to FIG. 5, a transverse cross section view taken along line 3A-3A in FIG. 2 depicting yet another embodiment of a mount and trolley subsystem 500 is shown. Mount 510A is shown affixed to ceiling 106A or 106B. It is to be appreciated that mount 510A may be attached by screw, rivet, adhesive or otherwise suitable engageable device.

Mount 510A is connected with rail 510B. Rail 510B is configured in this embodiment to be in the shape of an open “C” with the opening facing towards a side, somewhat similar to a garage door track. The lower curve of the “C” is configured to form a groove 510C. Trolley 512 has a trolley body 512A configured to be in a rough “U” shape, with an upper portion narrower than a lower portion, and a vertical centerline CL3 about which both vertical sides are equidistant. The vertical sides have two portions. The lower portion of trolley body 512A has an inner width WT1 and a vertical wall height of HT1. The upper portion of trolley body 512A has an inner width WT2 and a vertical wall height of HT2 (the total height of trolley body 512A equal to the sum of HT1 plus HT2). Trolley body centerline CL3 bisects each inner width WT1 and inner width WT2. Each of left and right vertical sides in the upper portion is configured differently. Trolley 512 is also generally configured to provide an attachment for tether 216A as attachment 512F.

One of the vertical sides is configured with an axle mount 512B. Axle mount 512B has an axle 512C rotably mounted therethrough. Axle 512C has a centerline CL4 or axis. A second type of wheel 512D is mounted on the portion of the axle 512C that extends between the two vertical sides of trolley body 512A. Wheel 512D has a wheel width WW and a vertical centerline that is substantially the same as the trolley body 512A vertical centerline CL3. Wheel width WW substantially matches rail 510B lower curve groove 510C. Wheel 512D contacts lower curve groove 510C, providing a rolling connection between rail 510C and trolley 512. It is to be appreciated that the shared centerline CL3 and the match between wheel width WW and groove 510C minimizes wobble of trolley 512. One or more sets (not shown) of axle mounts, axles, and wheels type 2 512D are contemplated, each set in line with the groove 510C of the rail 510B that is coupled to mount 510A.

The other of the vertical sides is configured with a single slide 514. Single slide 514 has a height HS and is attached to the inner portion of this other vertical slide at a distance DH from the top of upper portion of trolley body 512A. Single slide 514 is configured to contact the outside vertical portion of the “C” shape of rail 510B, providing a slidingly connection between rail 510C and trolley 512. Single slide 514 may contain friction reducing compounds or define all or a portion of a low friction interface operative to allow trolley 512 to slide along rail 510B. These compounds may include, but are not limited to, molecular ultra-high (UHMW) weight polyethylene tape, polytetraflouoroethylene (PTFE) tape, or other films, extruded films, skived film or foam type coatings. As used herein, friction reducing compounds and low friction interface refers to surfaces or components having static and/or kinetic a coefficient of friction less than 0.2.

It is to be appreciated that configuring centerline CL4 (placement of axle mount 512B) and size of wheel 512D will not interfere with sizing of mount 510B, and that single slide 514 is configured such that it is slidingly connected to rail 510B with wheel 512D having substantially same vertical centerline CL3 as trolley body 512A. It is also to be appreciated that the configuration providing both a rolling connection and a slidingly connection provides stability of trolley 512 in connection with rail 510B. It is to be appreciated that force transmitted through tether 216 (by various weights or forces) would act to either overcome W1 and permit sliding/rolling or be greater than WU and prevent sliding, thereby preventing rolling. As discussed herein, the assembly of system subassemblies provides the lower threshold force so that portions of the mount and trolley subsystems, the de-slack subsystem 600, 700, or 800 and the harness subsystem 900, 1000, or 1100 will not slide/roll due to their own weight, while permitting a slidingly connection with minimal additional force up to the upper threshold force. It is to be appreciated that in this embodiment, trolley 512 may be differently sized and shaped than trolley 312 and trolley 412, while being mated to a different mount and trolley subassembly 500 as discussed herein.

It is also to be appreciated that while a different size may be provided, configurations of the single slide 514 (such as by way of total surface contact area, surface roughness and the like) may provide substantially the same thresholds as a trolley 312 or trolley 412 due to different connection contact areas (and force vectors) related to single slide 514.

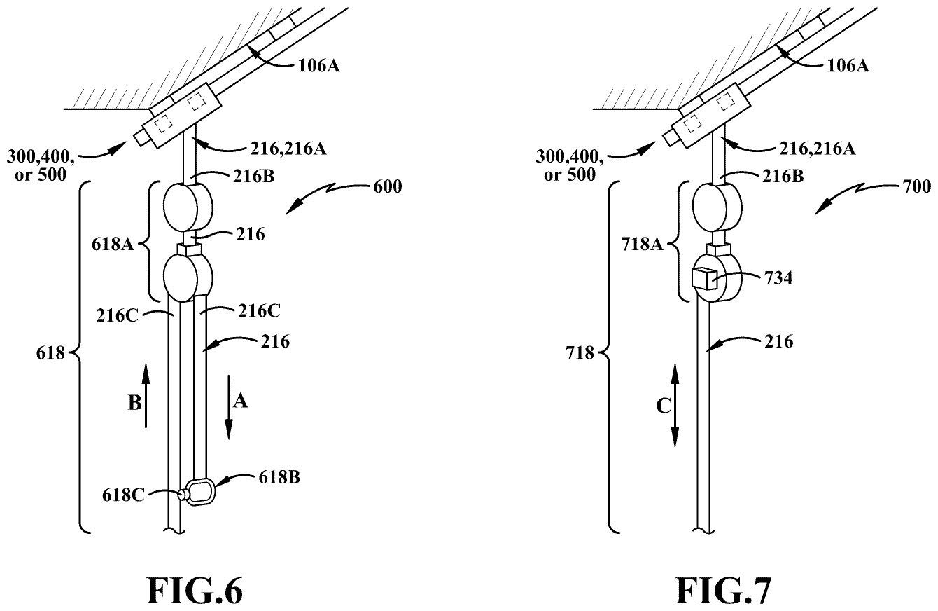

Turning to FIG. 6, a perspective view of a de-slack subsystem embodiment 600 is portrayed. In reference to a full system, for example, system 200, de-slack subsystem 618 is shown to be attached by tether 216A to mount and trolley subsystem 300, 400, or 500, which in turn has been fastened to ceiling 106A or 106B. A portion 216B of tether 216 is attached at its lower end to reel 618A. In this embodiment, reel 618A is comprised of two reels through with portions of tether 216 wind. It is to be appreciated that in some embodiments, the two reels may be combined into a single reel (not shown). For example, functional elements of both upper reel and lower reel of reel 618A can be co-located in a single larger reel, with side by side, top over bottom, or the like configurations. Upper reel of reel 618A serves to maintain the distance from mount and trolley subsystem 300, 400, or 500 to the lower reel of reel 618A. Tether portion 216C connects to the lower reel or other reel of reel 618A, and another portion 216D of tether 216 connects to a harness subsystem (not shown, embodiments discussed in relation to FIGS. 9A-11). In this embodiment, another portion 216C of tether 216 is movably attached to the lower reel of reel 618A, and extends in two directions with two ends. One of the two ends 216D is attached to a harness subsystem (not shown). The other end of the two ends 216E terminates in handle 618B. A switch 618C is located on the handle. With switch 618C un-activated, motion of portion 618B in direction of arrow A provides movement of portion 216D in direction of arrow B. With switch 618C activated, force pulling on portion 216E will not result in tether 216 moving, and instead, handle 618B may serve as a steadying implement. It is to be appreciated at start and completion of a stair traversal, deactivation of switch 618C may provide slack that may be helpful in donning or removing a harness (of the various embodiments disclosed herein). Harness subsystem embodiments will be discussed in relation to FIGS. 9A through 11.

In general, de-slack subsystems provide the ability of a user to don a harness of a harness subsystem and use the de-slack subsystem to remove any slack in the one or more portions of a tether (for example, tether 216), cinching any loose portion of a tether (i.e., slack) through a reel of the de-slack subsystem. Removing the slack provides an operative connection of the user (in the harness subsystem) to a movable trolley that is attached to a mount fixed to a ceiling above a set of steps, or stairs 102 to be traversed. Conversely, at appropriate times, such as for example at the beginning and end of a traversal, providing for the opposite operation of creating slack may benefit a user in donning or removing a harness.

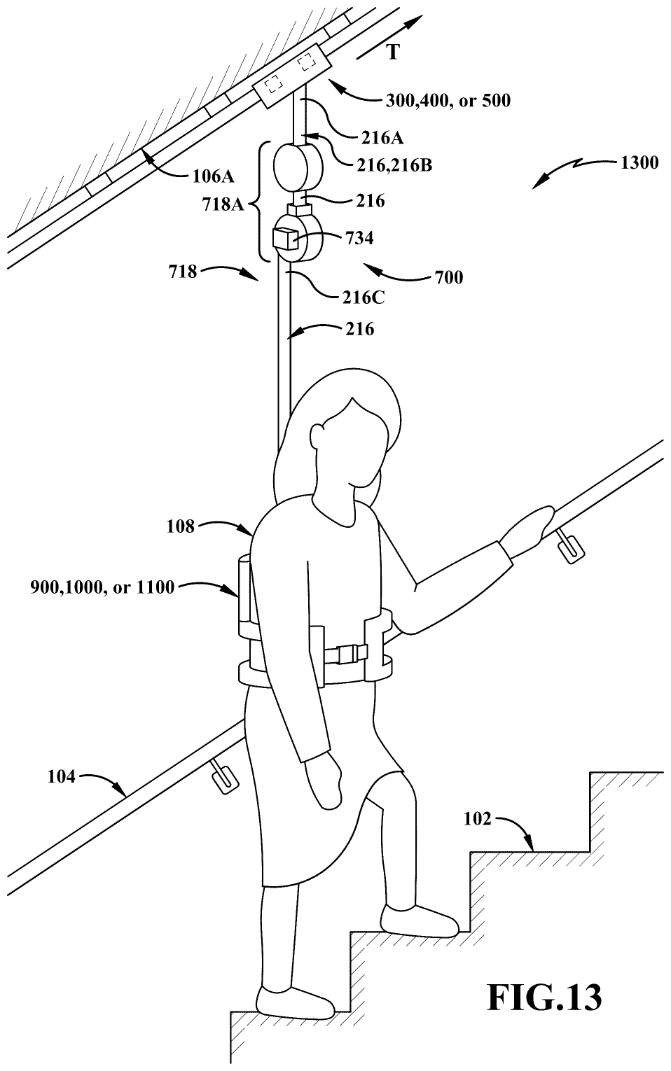

In relation to FIG. 6, handle 618B may be pulled in a direction away from lower reel of reel 618A, as indicated by arrow A. This action cinches a portion of tether 216 that is attached to a harness subsystem, removing slack that may exist between harness subsystem to de-slack subsystem 600, as indicated by arrow B, thereby providing the operative connection and ability to transfer a load imposed on the harness of the harness subsystem, as may occur with user 108 slipping and falling. One particular cinching of a portion of the tether 216 (for comfort of user 108 and tautness of the portion of the tether 216 in line with the portions of tether 216 in operative connection to de-slack subsystem 600) is fixed by a user by activating switch 618C on handle 618B. With activation, user 108 may place force on the handle and not cinch portions 216C of tether 216 further. This may provide an additional steadying element for user 108, with one hand using the handle, and the other hand of user 108 using handrail 104, as will be discussed in relation to FIGS. 12 and 13.

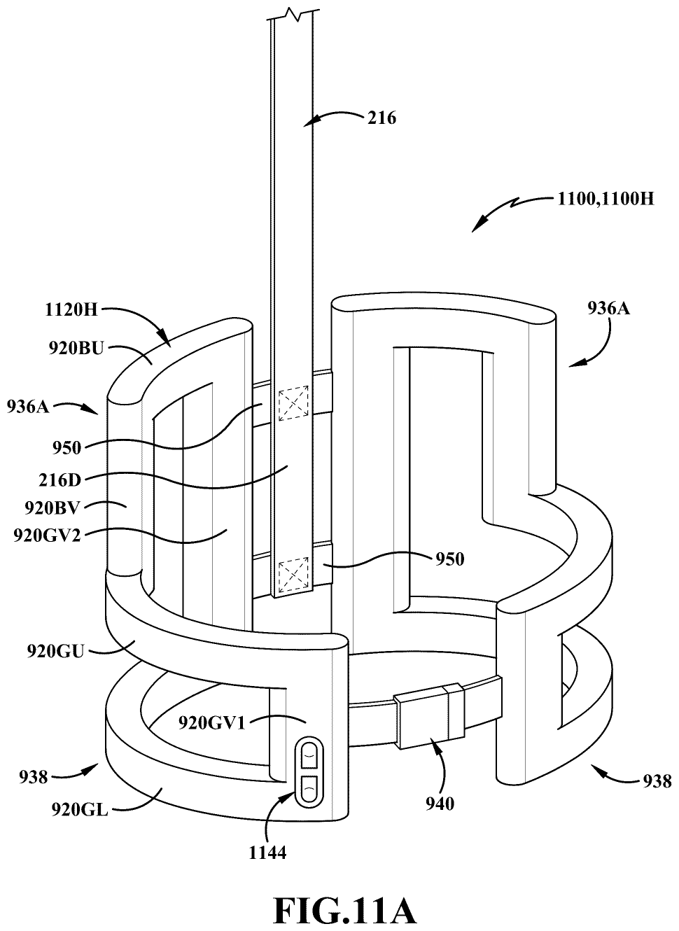

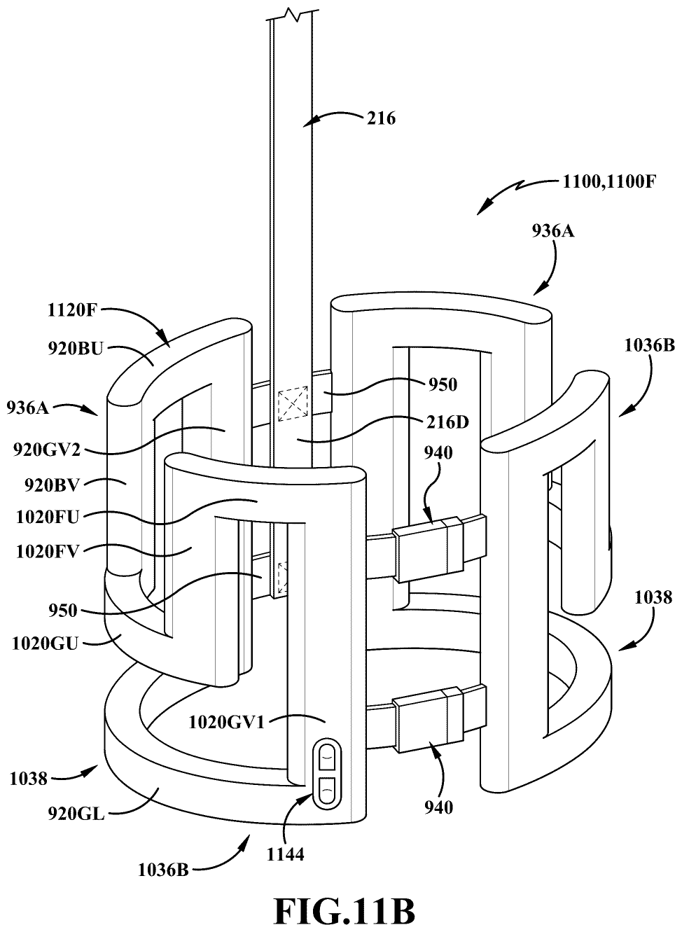

Turning to FIG. 7, a perspective view of another de-slack subsystem embodiment 700 is portrayed. In reference to a full system, for example, system 200, de-slack subsystem 718 is shown to be attached by tether 216A to mount and trolley subsystem 300, 400, or 500, which in turn has been fastened to ceiling 106A. Portion of tether 216 is attached at its lower end 216B to reel 718A. In this embodiment, reel 718A is comprised of two reels through with portions of tether 216 wind. It is to be appreciated that in some embodiments, the two reels of reel 718A may be combined into a single reel (not shown). Still further, the alternative de-slack mechanisms could be utilized instead the reel 718 to achieve a similar function of a “slack take up” mechanism without departing from the scope of the instant disclosure. Upper reel of reel 718A serves to maintain the distance from mount and trolley subsystem 300, 400, or 500 to the lower reel of reel 718A. Tether portion 216C connects to the lower reel of reel 718A, and another portion 216D of tether 216 connects to a harness subsystem (not shown, embodiments discussed in relation to FIGS. 9A-11). The lower reel of reel 718A is operative to retract (upwards arrow portion of arrow C and in reverse, to permit unwinding, downwards arrow portion of arrow C) the other portion of tether 216, coiling (or uncoiling) it firmly within the lower reel. Mechanisms for this operation are contemplated to be by physical or electronic buttons, located on the harness of the harness subsystem (not shown). For electronic control, receiver 734 is located on the lower reel of reel 718A. Upon activation of controller 1144 (discussed below in relation to FIG. 11A and FIG. 11B), a portion of tether 216 is wound taut and fixed in place. Reactivation of controller 1144 may release the tension. It is to be appreciated that once taut and fixed, any further force, such as for example, user 108 falling and pulling on the other portion of tether 216 would transmit the force up to the brake subsystem of the mount and trolley subsystem 300, 400, or 500.

In general, de-slack subsystems provide the ability of a user to obtain slack in portions of tether 216 to ease donning (and removal) of a harness of a harness subsystem and use the de-slack subsystem to remove any slack in the one or more portions of a tether (for example, the other portion of tether 216), cinching any loose portion of a tether through a reel of the de-slack subsystem. Removing the slack provides an operative connection of the user (in the harness subsystem) to a movable trolley that is attached to a mount fixed to a ceiling above a set of steps, or stairs 102 to be traversed. Conversely, at appropriate times, such as for example at the beginning and end of a traversal, providing for the opposite operation of creating slack may benefit a user in donning or removing a harness.

Turning to FIG. 8, a perspective view of another de-slack subsystem embodiment, which is shown in two different positions is portrayed in order to disclose environments in which a ceiling 106B above a set of steps, or stairs 102 is flat or horizontal. It is to be appreciated that embodiments discussed in relation to FIGS. 6-7 may be incorporated into the discussion of FIG. 8 and relate to the lower reel of reel 818A (designated by “X”). It is to be appreciated that user 108 employing reel 818A for the other portion of the tether 216 would provide a tether 216 taut throughout system 200 while in use, and slack to tether 216 as may be desired for donning and removal of a harness, such as any of the embodiments of harnesses discussed herein in relation to FIG. 9A through FIG. 11B.

As portrayed in FIG. 8, the embodiment of de-slack subsystem 800, portion 216A of tether 216 attached to the trolley of mount and trolley subsystem 300, 400, or 500 would extend a length L1 downwards to portion 216B at the upper reel of reel 818A. (position 1 is shown with items in ‘ghosted’ or broken lines, while the position 2 items are shown in solid lines). The upper reel of reel 818A operates to continuously remove slack from the tether 216 as user 108 climbs a set of steps, or stairs 102 (for example, from position 1 to position 2, see arrow T). This results in continuously diminishing L1 in a traversal of stairs 102, and as pictured at position 2 (see arrow DT), the portion 216A of tether 216 attached to the trolley of mount and trolley subsystem 300, 400, or 500 would extend a length L2 downwards to the upper reel of reel 818A, portion 216B changing to reflect tether 216 shortening. In other words, length L2 continuously changes such that that portion of the tether 216 throughout remains taut as discussed herein.

It is to be appreciated that the upper reel of reel 818A reverses action when user 108 traverses in the opposite direction descending a flight of stairs. The upper reel of reel 818A responds by slowly releasing sufficient length when force is below a predetermined threshold. Force above that predetermined threshold will result in the upper reel of reel 818A not releasing any additional portion of tether 216 until the force is restored below the predetermined threshold (as discussed herein in relation to W1 and WU).

Harness subsystems are discussed in relation to FIGS. 9A-11. It is to be appreciated that overall form of harness embodiments may vary, and that the embodiments pictured are merely highlighting certain aspects. Harness form factors may resemble harnesses known in the art such as water-related life jackets, climbing harnesses, or other forms known in the art except when explicitly stated otherwise, for example, “L” and “U” profile embodiments.

In relation to FIGS. 9A-9C, an embodiment of a harness subsystem 900 is shown. Harness 920 may be generally cylindrically shaped, with an anterior section and a posterior section. As shown in FIG. 9A, an isometric view of a first embodiment of a harness subsystem embodiment in a closed position, portion 216D of tether 216 is attached to harness 920 along the posterior section. In other embodiments (not shown), it is contemplated to have tether 216 attached at an anterior section, or at one or both of either side (e.g., a lateral location) between a posterior section and an anterior section. In an embodiment of an “L” profile, harness 920 has a portion back support 936A that would be in substantial contact with a back portion of user 108. Back support 936A may generally define a portion of the posterior section of harness 920. Elements of back support 936A may cover a portion of user 108 back and generally covers enough to comfortably support a user. Harness 920 has a portion girth support 938 that may define a portion of the posterior section of harness 920 and the entire anterior section of harness 920. Girth support 938 would be in substantial contact with a girth of user 108. Back support 936A and girth support 938 may be integrated, as shown in Harness subsystem 900. Girth support 938 will not contact the entire girth of user 108 and will have buckle 940 attached in the anterior section of harness 920. Buckle 940 may be most any type of buckle as known in the art and may serve to allow user 108 to easily don harness 920 (with buckle 940 open and unattached—as shown in FIG. 9B, an isometric view of the first embodiment of the harness subsystem embodiment in the open position), and then secure user 108 within harness 920 when buckle 940 is buckled. It is contemplated that harness 920 may be provided in many sizes to suit users of different sizes. Buckle 940 is sufficiently sturdy to support a predetermined maximum suggested user weight. Attachment 950 provides for attaching left and right portions of harness 920 to tether 216 at tether portions 216D.

FIG. 9C is a side elevation view of the first embodiment of the harness subsystem embodiment 900. This view portrays a limit of girth coverage of back support 936A. 936A provides for a wide range of movement of user arms, as well as back support. As shown, Girth support 938 is integrated with a lower portion of 936A. The side elevation view provides the “L” shape for this particular integrated embodiment. The “L” embodiment may comprise a right half and a left half of sturdy material, such as for example, hard foam. Right half may mirror left half, so a description of the right half only is provided for clarity. Harness 920 may comprise a first horizontal portion 920GL that encircles a substantial portion of a girth of a user in an arc from posterior to anterior. The anterior portion of 920GL merges into a vertical portion 920GV1, and the posterior portion of 920GL merges into a second vertical portion 920GV2. Both 920GV1 and 920GV2 extend superiorly, caudally, or upwardly (i.e., upwardly toward the head) from an upper surface of portion 920GL at the posterior and anterior portions respectively. Vertical portion 920GV1 may terminate at an upper end that is coplanar with an upper end of a second horizontal portion 920GU. Horizontal portion 920GU arcs from the anterior towards the posterior in substantially the same arc as portion 920GL, with a lesser arc distance, terminating with a merging into a back support vertical portion 920BV. The bottom of back support vertical portion 920BV may be coplanar with the bottom of portion 920GU. Portion 920BV extends superiorly, caudally, or upwardly (i.e., upwardly toward the head) from an upper surface of portion 920GU at a determined arc position of back support 936A. Vertical portion 920BV may terminate at an upper end that is coplanar with an upper end of a horizontal portion 920BU. Portion 920BU forms the upper portion of back support portion 936A of harness 920. Portion 920BU extends in an arc in a posterior direction substantially similar to the arc of portion 920GL below portion 920BU and terminates in a merging with second vertical portion 920GV2. The top of portion 920BU may be coplanar with the top of portion 920GV2. In this manner, girth support 938 and back support 936A share portions of harness 920 in an advantageous manner. Collectively, the portions of the harness could define an L-shaped opening that extends laterally through the material that forms the harness.

It is to be appreciated that in other embodiments, many designs (form factors) may supply varying degrees of integration between one or more portions.

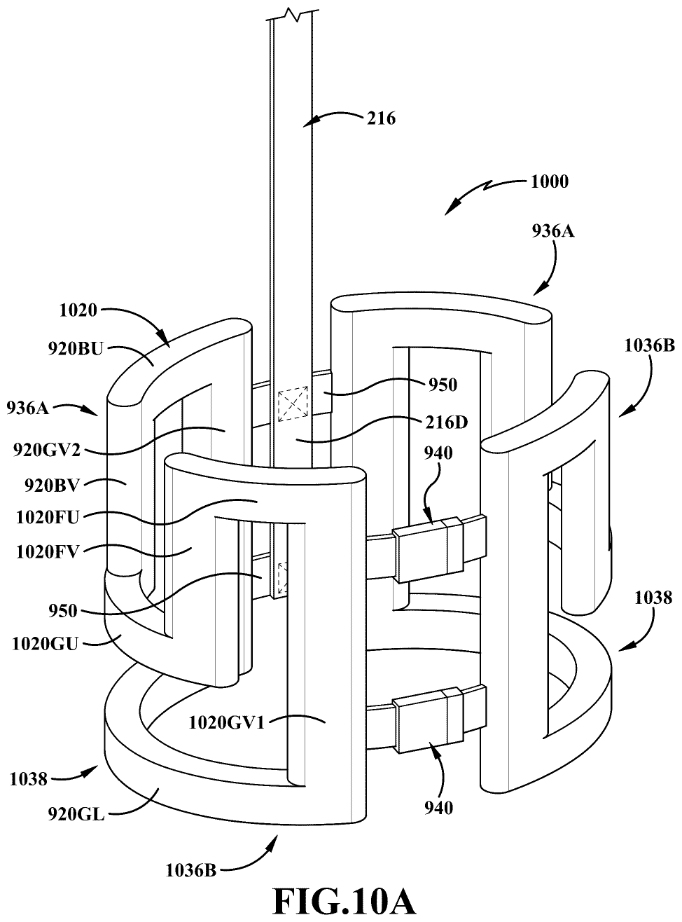

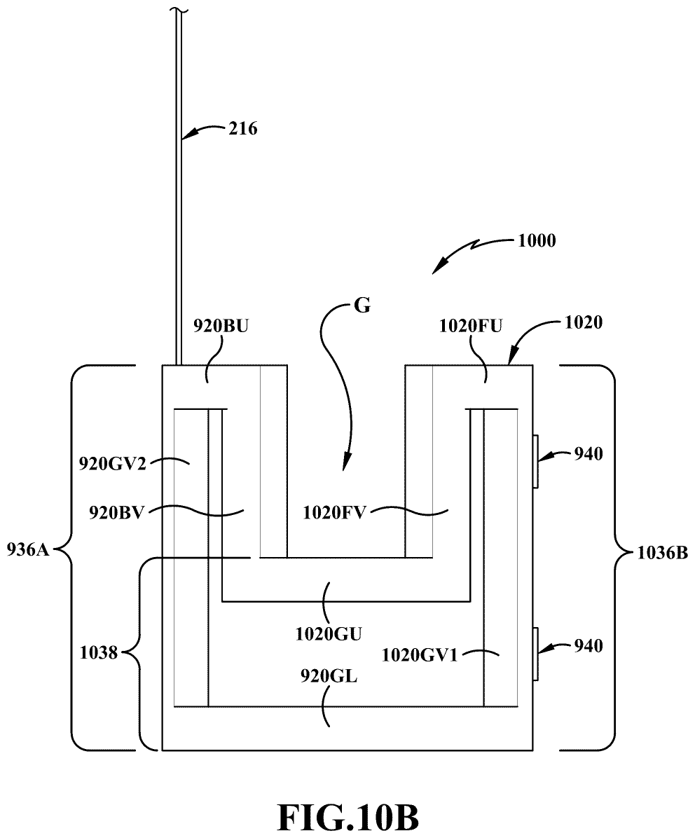

Turning now to FIG. 10A, an isometric view of a second embodiment 1000 of a harness subsystem embodiment in a closed position, and FIG. 10B, a side elevation view of the second embodiment 1000 of the harness subsystem embodiment are shown. Harness 1020 is generally cylindrically shaped, with a back support 936A in a posterior section and a front support 1036B in an anterior section. A girth support portion 1038 is shown in FIG. 10A, portion 216D of tether 216 is attached to harness 1020 along the posterior section. In other embodiments (not shown), it is contemplated to have tether 216 attached at an anterior section, or at one or both of either side (e.g., a lateral location) between a posterior section and an anterior section.

Harness 1020 has a portion back support 936A that would be in substantial contact with a back portion of user 108 and generally contacts sufficiently to comfortably support user 108. Harness 1020 has a portion front support 1036B. In embodiments, and as shown in FIGS. 10A-B, front support 1036B may mirror back support 936A. In other embodiments, front support 1036B may provide different coverage of user 108 and have a different form factor. In an embodiment, front support 1036B may have a buckle 940.

Harness 1020 has a portion girth support 1038, and girth support 1038 would be in substantial contact with a girth of user 108. Back support 936A, front support 1036B, and girth support 1038 may be integrated, as shown in harness subsystem 1000. Girth support 1038 will not contact the entire girth of user 108 and will have one or more buckle 940. One or more buckle 940 may be most any type of buckle as known in the art and serves to allow user 108 to easily don harness 1020 (with one or more buckle 940 open and unattached), and then secure user 108 within harness 1020 when one or more buckle 940 is buckled. It is contemplated that harness 1020 may be provided in many sizes to suit different user sizes. One or more buckle 940 is sufficiently sturdy to support a predetermined maximum suggested user weight. Attachment 950 provides for attaching left and right portions of harness 1020 to tether 216 at tether portions 216D.

FIG. 10B portrays a side elevation view of the second embodiment of the harness subsystem embodiment 1000. This view portrays a particular embodiment of a “U” profile. The “U” embodiment may comprise a right half and a left half of sturdy material, such as for example, hard foam. The right half may mirror the left half, so a description of the right half only is provided for clarity. Further, it is to be appreciated that front support portion 1036B of the anterior of harness 1020 may mirror the back support portion 936A of the posterior of harness 1020, thus yielding advantages in fabrication.

Harness 1020 may comprise a first horizontal portion 920GL of girth support 1038 that encircles a substantial portion of a girth of a user from an arc posterior to anterior. The anterior portion of 920GL merges into a vertical portion 1020GV1, and the posterior portion of 920GL merges into a second vertical portion 920GV2. Both 1020GV1 and 920GV2 extend superiorly, caudally, or upwardly (i.e., upwardly toward the head) from an upper surface of portion 920GL at the posterior and anterior portions respectively. Vertical portion 1020GV1 may terminate at an upper end that is coplanar with an upper end of a front support portion 1020FU. Front support portion 1020GU arcs from the anterior towards the posterior in substantially the same arc as portion 920GL below, with a lesser arc distance, terminating with a merging into a front support vertical portion 1020FV. Front support vertical portion 1020FV extends inferiorly, cephalically, or downwardly (i.e., downwardly away from the head) from an upper position 1020FU. The bottom of front support vertical portion 920BV may be coplanar with the bottom of portion 1020GU. Portion 1020GU arcs from the merged posterior of 1020FV horizontally towards a merged anterior of portion 920BV. This arc may mirror arc of portion 920GL. Portion 920BV extends superiorly, caudally, or upwardly (i.e., upwardly toward the head) from an upper surface of portion 1020GU at a determined arc position of back support 936A. Vertical portion 920BV may terminate at an upper end that is coplanar with an upper end of a horizontal portion 920BU. Portion 920BU forms the upper portion of back support portion 936A of harness 920. Portion 920BU extends in an arc in a posterior direction substantially similar to the arc of portion 920GL below portion 920BU and terminates in a merging with second vertical portion 920GV2. The top of portion 920BU may be coplanar with the top of portion 920GV2. Top of portion 920BU may also be coplanar with top of portion 1020FU. In this manner, girth support 1038 share portions of harness 1020 with back support 936A and front support 1036B in an advantageous manner. In this embodiment, girth support 1038 is integrated with lower portions of both back support 936A and front support 1036B. As depicted in FIGS. 10A-B, girth support 1038 is continuous with back support 936A in the aft portion of harness 1020, and girth support 1038 is continuous with front support 1036B in the forward portion of harness 1020. Collectively, the portions of the harness could define an U-shaped opening that extends laterally through the material that forms the harness.

As shown in FIG. 10B, the vertical portions 920BV and 1020FV, along with girth portion signified portions of back support 936A and front support 1036B define a gap “G” between the posterior and anterior portions of harness 1020, and above a portion of girth support 938. This gap provides for a range of movement of user arms, as well as support for a user under the user's arms. Portions posterior (for back support 936A) and anterior (for front support 1036B) still provide back and front support.

It is to be appreciated that in other embodiments, many designs (form factors) may supply varying degrees of integration between one or more portions.

Referring to FIGS. 11A-B, harness subsystems 1100H or 1100F are shown with harness 1120H in FIG. 11A and harness 1120F in FIG. 11B. FIG. 11A is an isometric view of the first embodiment of a harness subsystem embodiment illustrating another aspect of the subsystem. FIG. 11B is an isometric view of the second embodiment of a harness subsystem embodiment illustrating another aspect of the subsystem. These embodiments are provided resembling harness subsystems 900 and 1000 as described herein above. The embodiments provide an additional feature, controller 1144.

While it is shown that controller 1144 is located at the lower right front portion of harness 1120H and harness 1120F, location may vary with embodiments. The embodiments shown provide this location for ease of a right-handed user, such as user 108.

As was discussed in relation to de-slack subsystem 700 (in relation to FIG. 7), the lower reel of reel 718A is operative to retract the other portion 216B of tether 216, coiling it firmly within the lower reel of reel 718A. Mechanisms for this operation are contemplated to be by physical or electronic buttons, operatively located on controller 1144 of the harness subsystems 1100H/1100F. For electronic control, receiver 734 is located on the lower reel of reel 718A.

Having thus described exemplary embodiments of subsystems of system 200, its operation will be discussed with reference to some exemplary features in embodiments of use cases 1200, 1300, or 1400.

Turning to FIG. 12, a diagrammatic view of a use embodiment 1200 of a system with selected aspects is shown. In the embodiment, user 108 has started traversing stairs 102 upward. User 108 is being assisted with handrail 104 and handle 618B. In this embodiment, ceiling 106A is parallel to the ascent line or slope of stairs 102. Attached to ceiling 106A is a mount and trolley subsystem, such as for example, mount and trolley subsystem 300, 400, or 500. A portion of tether 216 is attached to mount and trolley subsystem 300, 400, or 500 at tether 216A. Another portion 216B of tether 216 is attached to a de-slack and harness subsystem, for example, de-slack and harness subsystem 600, as disclosed herein. As user 108 traverses the steps, the pull on a harness of de-slack and harness subsystem 600 would transmit a force through tether 216 up to mount and trolley subsystem 300, 400, or 500. As this slight force would be greater than W1, the trolley 312, 412, or 512 within mount and trolley subsystem 300, 400, or 500 would slide (or permit to roll) along the rail 310B, or 510B within mount and trolley subsystem 300, 400, or 500, keeping the trolley 312, 412, or 512 substantially above user 108 as seen by arrow T.

Were user 108 to slip or misstep and start to fall, user 108 may steady themselves with handle 618B. If the slip or misstep is more severe, user 108 would be secured by a harness of de-slack and harness subsystem 600, and user's 108 weight would be forced on tether 216, with the force transmitting through de-slack and harness subsystem 600 upwards to mount and trolley subsystem 300, 400, or 500.

As described herein, this force exceeds threshold WU. As any force applied greater than WU provides enough force to stop trolley 312, 412, or 512 from traversing along the path of rail 310B or 510B of mount and trolley subsystem 300, 400, or 500, user 108 supported by a harness of de-slack and harness subsystem 600 be prevented from landing awkwardly and would not fall to stairs 102, let alone fall further down stairs 102. Instead, user 108 will be only slightly lowered from a normal stepping position, and thus able to recontrol themselves, and plant themselves firmly back on stairs 102. Thus, with control re-established, the force from the weight WU is released from the brake function, and trolley 312, 412, or 512 is once again within a force range of being slidingly connected, allowing user 108 to continue traversing stairs 102. In this manner, user 108 merely needs to traverse stairs 102 with a minimal force to overcome W1 and the trolley 312, 412, or 512 will slide (or permit to roll) along.

In this embodiment, at the finish of the traverse, user 108 could again activate switch 618C, releasing tension in tether 216. This achieves a force at or below threshold W1, preventing sliding/rolling, as well as providing slack to tether 216, which eases movement of a harness. After user 108 removes the harness, user 108 can complete any activity at that level and, desiring to return to the bottom of stairs 102, the system is available, and would not have slid (or permitted to roll) down rail 310B or 510B of the portion of the mount and trolley subsystem 310, 410, or 510 to the bottom of stairs 102.

In this embodiment, at the start of the traverse, user 108 could comfortably don a harness of de-slack and harness subsystem 600, as slack in tether 216 would be present (or may be obtained as described herein). After donning and securing the harness, user 108 can pull handle 618B to put tether 216 into tension. User 108 can then activate switch 618C, such that further pulling on handle 618B does not add further tension to tether 216.

Turning to FIG. 13, a diagrammatic view of another use embodiment 1300 of a system with selected aspects is shown. Use case 1300 is similar to use case 1200 with the exception of selected harness embodiment and operation thereof. In this embodiment, at the start of the traverse, user 108 could comfortably don a harness of de-slack and harness subsystem 700, as slack in tether 216 would be present (or may be obtained as described herein). After donning and securing the harness, user 108 can activate controller 1144 that puts tether 216 into tension. As pictured in FIG. 13, user 108 has started traversing stairs 102 upward. User 108 is being assisted with handrail 104. In this embodiment, ceiling 106A is parallel to the slope or ascent line of stairs 102. Attached to ceiling 106A is a mount and trolley subsystem, such as for example, mount and trolley subsystem 300, 400, or 500. A portion 216A of tether 216 is attached to mount and trolley subsystem 300, 400, or 500. Another portion 216B of tether 216 is attached to a de-slack and harness subsystem, for example, de-slack and harness subsystem 700, as disclosed herein. As user 108 traverses the steps, the pull on a harness of de-slack and harness subsystem 700 would transmit a force through tether 216 up to mount and trolley subsystem 300, 400, or 500. As this slight force would be greater than W1, the trolley (312, 412, or 512) within mount and trolley subsystem 300, 400, or 500 would slide (or permit to roll) along the rail 310B or 510B within mount and trolley subsystem 300, 400, or 500, keeping the trolley (312, 412, or 512) substantially above user 108 (as shown by arrow T).

Were user 108 to slip or misstep and start to fall, user 108 would be secured by a harness of de-slack and harness subsystem 700, and user's weight would be forced on tether 216, with the force transmitting through de-slack and harness subsystem 700 upwards to mount and trolley subsystem 300, 400, or 500.

As described herein, this force exceeds threshold WU. As any force applied greater than WU provides enough force to stop trolley 312, 412, or 512 from traversing along the path of rail 310B or 510B of the mount and trolley subsystem 300, 400, or 500, User 108 supported by a harness of de-slack and harness subsystem 700 would be prevented from landing awkwardly and would not fall to stairs 102, let alone further down stairs 102. Instead, user 108 will be only slightly lowered from a normal stepping position, and thus able to recontrol themselves, and plant themselves firmly back on stairs 102. Thus, with control re-established, the force from the weight WU is released from the brake function, and the trolley 312, 412, or 512 is once again within a force range of being slidingly connected, allowing user 108 to continue traversing stairs 102. In this manner, user 108 merely needs to traverse stairs 102 with a minimal force to overcome W1 and trolley 312, 412, or 512 will slide (or permit to roll) along.

In this embodiment, at the finish of the traverse, user 108 could again use controller 1144 to release tension in tether 216. This achieves a force at or below threshold W1, preventing sliding/rolling, as well as providing slack to ease removing of the harness. After user 108 removes the harness, user 108 can complete any activity at that level and, desiring to return to the bottom of stairs 102, the system 200 is available, and would not have had the harness slide (or permitted to roll) down the rail 310B or 510B of the portion of the mount and trolley subsystem 310, 410, or 510 to the bottom of stairs 102.

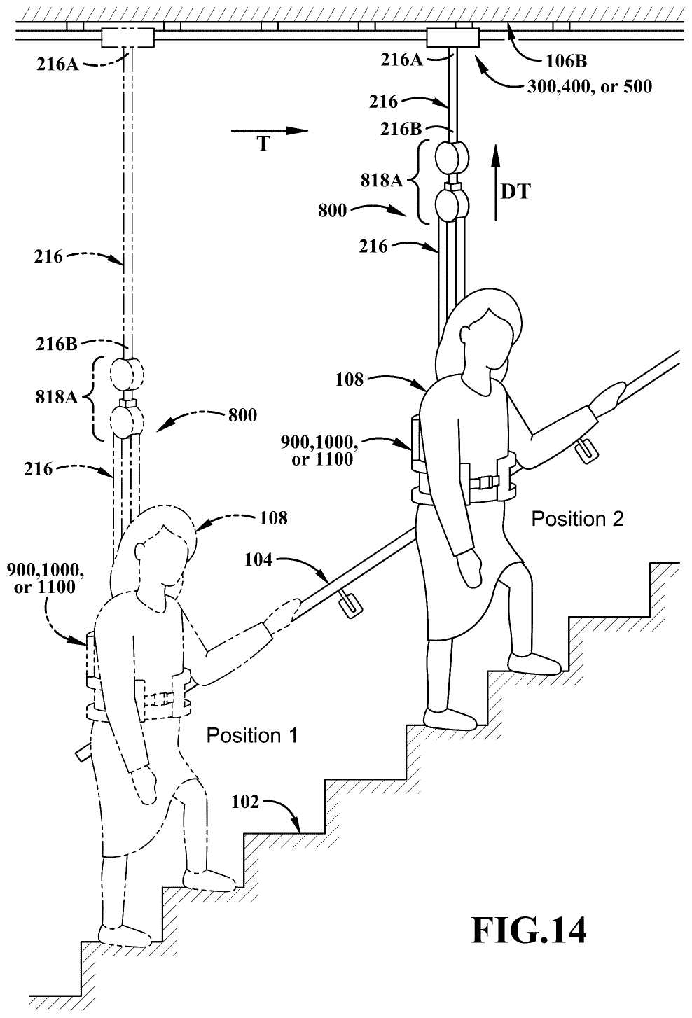

Turning to FIG. 14, a diagrammatic view of another use embodiment 1400 of a system with selected aspects is shown. Use case 1400 reflects the embodiment shown in FIG. 8, discussed herein above. In an embodiment, a first position and a second position are portrayed to disclose environments in which a ceiling 106B above a set of steps, or stairs 102 is flat, or horizontal (position 1 is shown with items in ‘ghosted’ or broken lines, while the position 2 items are shown in solid lines). It is to be appreciated that embodiments of selected subsystems discussed in relation to FIGS. 6-7, and 12-13 may be incorporated into the discussion of FIG. 8, for example, subsystems relating to the lower reel of reel 818A (designated by “X”). It is to be appreciated that user 108 employing reel 818A for a portion of the tether 216 would provide a tether 216 taut throughout system 200 during a traversal.

In FIG. 14, user 108 is not using handle 618B, and instead, the handle 618B is shown as being clipped to the harness. At position one, the portion 216A of tether 216 attached to the trolley of mount and trolley subsystems 300, 400, or 500 would extend a length L1 downwards to the upper reel of reel 818A (portion 216B). The upper reel of reel 818A operates to continuously remove slack from the tether 216 as a user climbs a set of steps, or stairs 102. This results in continuously diminishing L1 in a traversal of stairs 102 (see arrows T and DT), and as pictured at position 2, the portion 216A of tether 216 attached to the trolley of mount and trolley subsystem 300, 400, or 500 would extend a length L2 downwards to the upper reel of reel 818A (portion 216B). Length of that portion 216B of tether 216 changes such that the tether 216 throughout remains taut during the traversal.

As user 108 traverses the steps, the pull on a harness of de-slack and harness subsystem 800 would transmit a force through tether 216 up to mount and trolley subsystem 300, 400, or 500. As this slight force would be greater than W1, trolley 312, 412, or 512 within mount and trolley subsystem 300, 400, or 500 would slide (permit to roll) along the rail 310B or 510B within mount and trolley subsystem 300, 400, or 500, keeping trolley 312, 412, or 512 substantially above User 108.

Were user 108 to slip or misstep and start to fall, user 108 would be secured by a harness of de-slack and harness subsystem 800, and user's weight would be forced on tether 216, with the force transmitting through de-slack and harness subsystem 800 upwards to mount and trolley subsystem 300, 400, or 500.

As described herein, this force exceeds threshold WU. As any force applied greater than WU provides enough force to stop trolley 312, 412, or 512 from traversing along the path of rail 310B or 510B of the mount and trolley subsystem 300, 400, or 500, User 108 supported by a harness of de-slack and harness subsystem 700 would be prevented from landing awkwardly and would not fall to stairs 102, let alone further down stairs 102. Instead, user 108 will be only slightly lowered from a normal stepping position, and thus able to recontrol themselves, and plant themselves firmly back on stairs 102. Thus, with control re-established, the force from the weight WU is released from the brake function, and the trolley 312, 412, or 512 is once again within a force range of being slidingly connected, allowing user 108 to continue traversing stairs 102. In this manner, user 108 merely needs to traverse stairs 102 with a minimal force to overcome W1 and trolley 312, 412, or 512 will slide (or permit to roll) along.

In this embodiment, at the start of the traverse, user 108 could comfortably don a harness of de-slack and harness subsystem 800, as slack in tether 216 would be present (as handle 618B is unrestrained with switch 618C deactivated). After donning and securing the harness, user 108 can pull handle 618B to put tether 216 into tension. User 108 can then activate switch 618C, such that further pulling on handle 618B does not add further tension to tether 216.

In this embodiment, at the finish of the traverse, user 108 could de-activate switch 618C, releasing tension in tether 216. This achieves a force at or below threshold W1, preventing sliding/rolling, as well as providing slack to tether 216, which eases movement of the harness. After user 108 removes the harness, user 108 can complete any activity at that level and, desiring to return to the bottom of stairs 102, the system is available, and would not have slid (or permitted to roll) down rail 310B or 510B of the portion of the mount and trolley subsystem 310, 410, or 510 to the bottom of stairs 102.

It is to be appreciated that the upper reel of reel 818A reverses action when a user traverses in the opposite direction descending a flight of stairs 102. The upper reel of reel 818A responds by slowly releasing sufficient length when force is below a predetermined threshold. Force above that predetermined threshold will result in the upper reel of reel 818A not releasing any additional portion of tether 216 until the force is restored below a predetermined threshold (for example, a force of WU).

In another embodiment, at the start of the traverse, user 108 could comfortably don a different embodiment of a harness of de-slack and harness subsystem 800, as slack in tether 216 would be present (or may be obtained as described herein). After donning and securing the harness, user 108 can activate controller 1144 that puts tether 216 into tension.

In this other embodiment, at the finish of the traverse, user 108 could again use controller 1144 to release tension in tether 216. This achieves a force at or below threshold W1, preventing sliding/rolling as well as providing slack to ease use of the harness. After user 108 removes the harness, user 108 can complete any activity at that level and, desiring to return to the bottom of stairs 102, the system is available, and would not have slid (or permitted to roll) down rail 310B or 510B of the portion of the mount and trolley subsystem 310, 410, or 510 to the bottom of stairs 102.

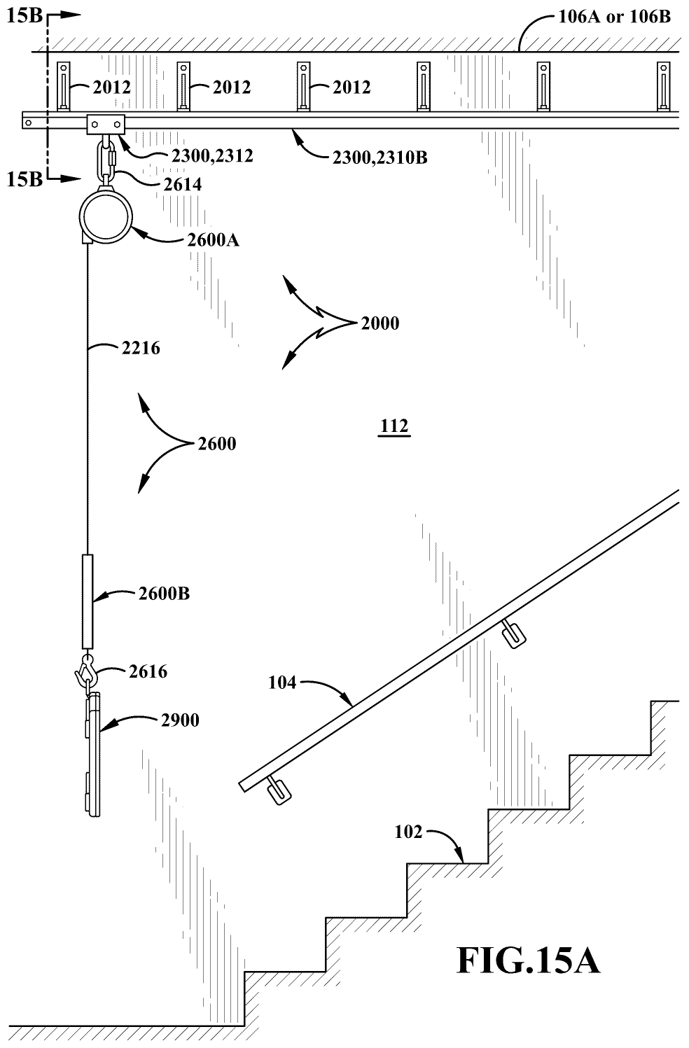

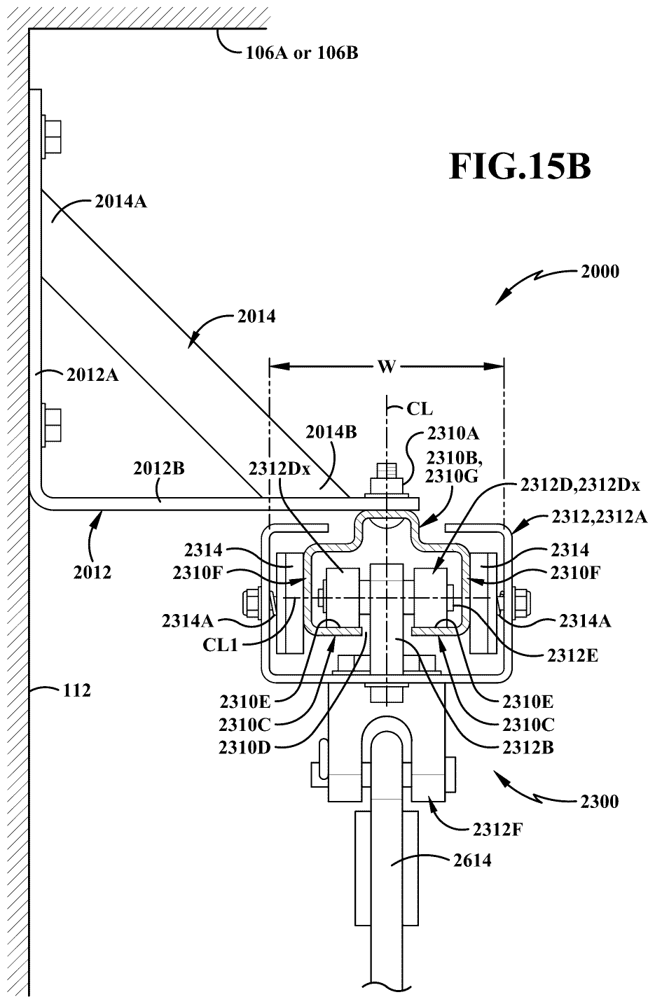

Referring now to FIG. 15A, a diagrammatic view of another example embodiment of a stair safety system 2000 is shown. System 2000 may comprise a mount and trolley subsystem 2300, a de-slack tether subsystem 2600, and a harness subsystem 2900. These different embodiments highlight the ability to put various subsystems together in a home environment. A set of steps, or stairs 102, may have zero, one or two handrails 104. Above stairs 102, there may be a ceiling 106A that is substantially parallel to the angle or slope of stairs 102. Alternatively, there may be a ceiling 106B that is substantially horizontal or flat above stairs 102 (see also FIG. 8). Alternatively, there may be a wall 112 that is substantially perpendicular or adjacent to the stairs 102. Component subsystems of system 2000 will be covered in greater detail in relation to discussions of FIG. 15A through FIG. 21.

With continued reference to FIG. 15A, mount and trolley subsystem 2300, (which shall be discussed in more detail herein), may be configured in a home as part of exemplary system 2000. It is to be appreciated portions of the mount and trolley subsystem 2300 will be connected to a vertical side wall 112 (instead of a ceiling 106A or 106B) and that the mounting to the wall 112 may be attached by screw, rivet, adhesive or otherwise suitable engageable device.

Attached to mount and trolley subsystem 2300 is tether 2216. It is to be appreciated that tether 2216 may form a plurality of sections and be attached to a plurality of items as discussed herein. Tether 2216 will be attached to trolley 2312 by connecter 2614 as discussed herein. Tether 2216 will have a second operative connection with de-slack subsystem 2600, as will be discussed herein. De-slack subsystems may comprise one or two reels 2600A and 2600B (or other “slack take up” mechanisms that may not necessarily be in the form of a reel) in various embodiments. In two-reel embodiments, the reels may have a portion tether 2216 affixing the reels to each other. For example, functional elements of both upper reel 2600A and lower reel 2600B can be co-located in a single larger reel, with side by side, top over bottom, or the like configurations.

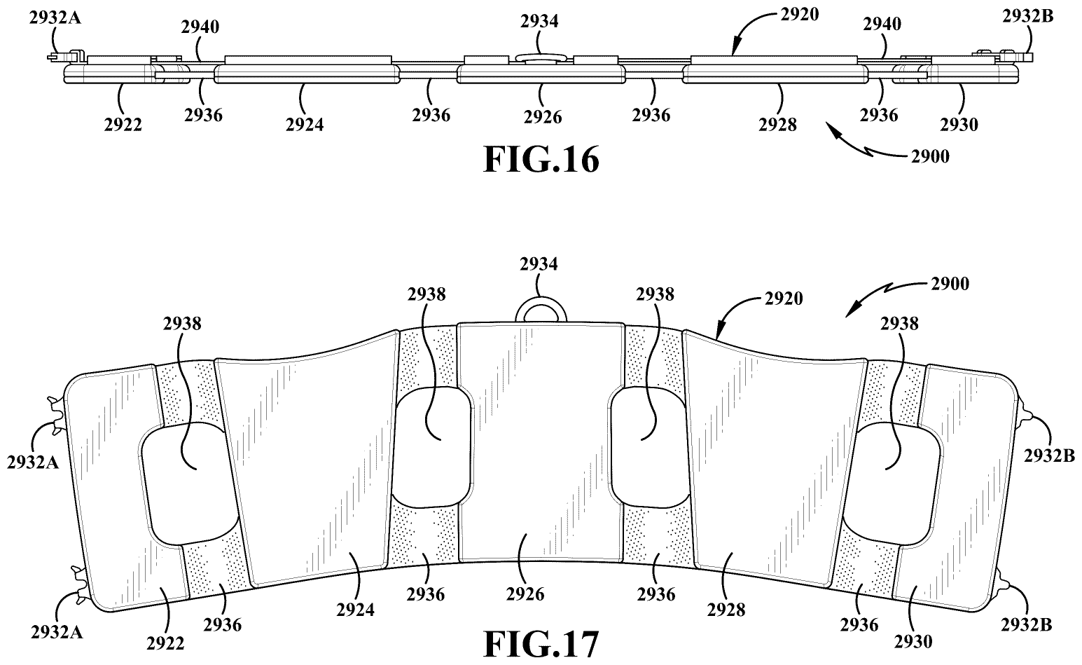

Further shown in FIG. 15A is harness subsystem 2900. Harness subsystem 2900 in various embodiments that will be discussed in greater detail in relation to FIG. 16 through FIG. 21, is attached at the lower end of de-slack subsystem 2600 by way of a connector 2616. As noted earlier, tether 2216 may be comprised of one or more separate sections or portions. It is to be appreciated that attachments of tether 2216 to the various items may be by any known method, and may include without limitation by screw, rivet, adhesive or otherwise suitable engageable device.

Turning now to FIG. 15B, a transverse cross section view taken along line 15B-15B in FIG. 15A depicting an embodiment of a mount and trolley subsystem 2300 is shown. Mount 2310A is shown affixed to vertical side wall 112 (instead of being affixed to ceiling 106A or 106B, as in the other embodiments). It is to be appreciated that mount 2310A may be attached by screw, rivet, adhesive or otherwise suitable engageable device.

Affixed to mount 2310A is rail 2310B, and rail 2310B is configured in this embodiment to be in the shape of an open “C” with short legs 2310C and an opening 2310D defined by short legs 2310C of the “C” facing downward. It is to be appreciated that centerline CL bisects the mount and trolley subsystem into mirror left and right portions in this view. The substantially horizontal portion of the inner (top) short legs is denoted as 2310E. Rail 2310B has outer portions 2310F of the left and right outer “C” (the outer top and bottom of the “C” shape). Further, rail 2310B and a generally downward facing U-shaped protrusion 2310G on the long side of the “C” of rail 2310B. The mount 2310A is affixed to the downward facing U-shaped protrusion 2310G. It is to be appreciated that mount and trolley subsystem 2300 may be comprised of a plurality of mounts 2310A and modular rails 2310B. Modular rails 2310B are contemplated to be available in a number of predetermined lengths, with suitable connecting mechanisms as may be known in the art (not shown). It is contemplated that end-to-end connections may be slidably connected or male/female connected or able to be connected in a suitable manner. Given that the shown embodiment is a residential application, and not a commercial application, it is envisioned that the length of each of modular rails 2310B is about four feet or less.

Trolley 2312 may be connected to the wall 112 by mount 2012. It is to be understood that mount 2012 may be any mount that one skilled in the art would understand to be functional. In this particular embodiment, mount 2012 is an L-shaped bracket that connects to the mount 2310A of the mount and trolley system 2300. The mount 2012 includes a vertically oriented first leg 2012A and a horizontally oriented second leg 2012B. The vertically oriented first leg 2012A and the horizontally oriented second leg 2012B may be disposed at a right angle relative to each other. Vertical leg 2012A may define apertures that permit screws or bolts to be inserted therethrough to connect the mount 2012 to the wall 112 by inserting those screws into studs in the wall 112. The horizontal leg 2012B extends from the vertical leg 2012A that is affixed to the wall to a free terminal end. The mounts 2310A are located near the distal terminal end of horizontal leg 2012B. There may be a cross brace 2014 that extends at an angle between the vertical leg 2012A and the horizontal leg 2012B to provide further support for the mount 2012. In the embodiment in which two bolts or screws are utilized to connect the vertical leg 2012A to the wall 112, the cross brace 2014 may have an end 2014A that is located vertically between the two bolts or screws. The lower end 2014B of cross brace 2014 is fixedly connected to the horizontal leg 2012B near the distal end thereof.

In this embodiment, trolley 2312 is configured to have a trolley body 2312A in the shape of an open “C” facing upward. Trolley body 2312A has an inner width W and a centerline CL to that width. Attached vertically on the inside of the “C” at centerline CL of inner width W of trolley body 2312A is inner support 2312B. Inner support 2312B is portrayed in this embodiment as having a length less than the length of trolley body 2312A. It is contemplated that for other embodiments, both length of trolley body 2312A and length of inner support 2312B may differ and may be chosen for design considerations. A plurality of inner support 2312B may be attached to trolley body 2312A. For each inner support 2312B, a wheel set 2312D, mounted on wheel set axle 2312E, places a plurality of wheels 2312Dx equidistant from centerline CL1 of the length of trolley body 2312. In this embodiment, left and right wheels 2312Dx are positioned on the inner, lower portions 2310E of rail 2310B. This surface provides a rolling connection for the wheels 2312Dx of trolley 2312. Trolley 2312 is also generally configured to provide an attachment for tether 2216 as attachment 2312F which connects to the connector 2614 that is directly connected to tether 2216. Trolley 2312 may be further configured to have sliding member 2314 in sliding contact with outer portions 2310F of rail 2310B. Sliding member 2314 may contain friction reducing compounds that define all or a portion of a low friction interface operative to permit (or not permit) wheels 2312Dx to roll on short legs 2310C. These compounds may include, but are not limited to, ultra-high molecular weight (UHMW) polyethylene tape, polytetraflouoroethylene (PTFE) tape, or other films, extruded films, skived film or foam type coatings. As used herein, friction reducing compounds and low friction interface refers to surfaces or components having static and/or kinetic a coefficient of friction less than 0.2. Sliding member 2314 may also include springs 2314A which may absorb any force that is applied to the trolley 2312. The springs 2314A may act as a braking mechanism to slow the wheels 2312Dx down if there is a downward force applied.

As discussed herein, the assembly of system subassemblies provides the lower threshold force so that portions of the mount and trolley subsystems, the de-slack subsystem and the harness subsystem will not slide/roll due to their own weight, while permitting a slidingly connection with minimal additional force up to the upper threshold force as discussed herein. It is to be appreciated that a band of force values between the lower threshold value and the upper threshold value permit wheels 2312Dx to roll and trolley 2312 to move. It is to be appreciated that trolley body 2312A may be structurally reinforced with a plurality of reinforcements (not shown).

It is to be understood that the second embodiment 2000 of the mount and trolley system 2300 and de-slack subsystem 2600 work substantially similar to the previous embodiments described above.

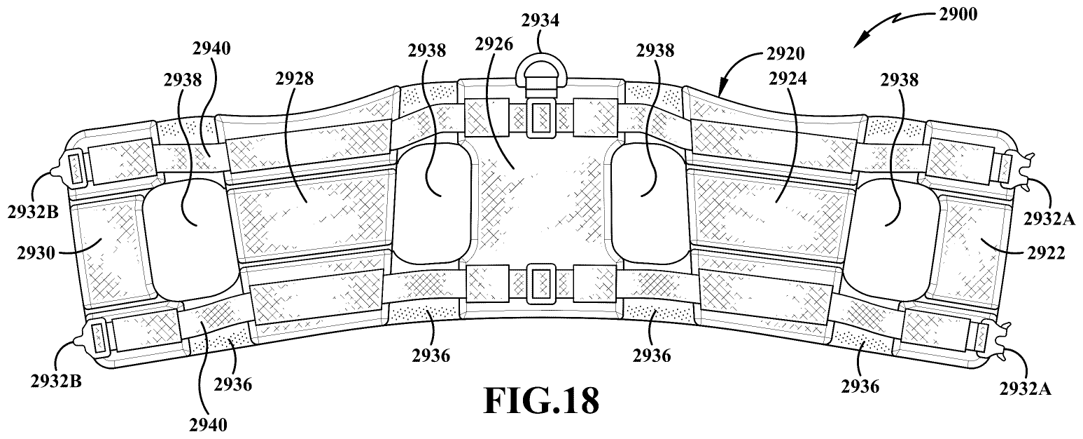

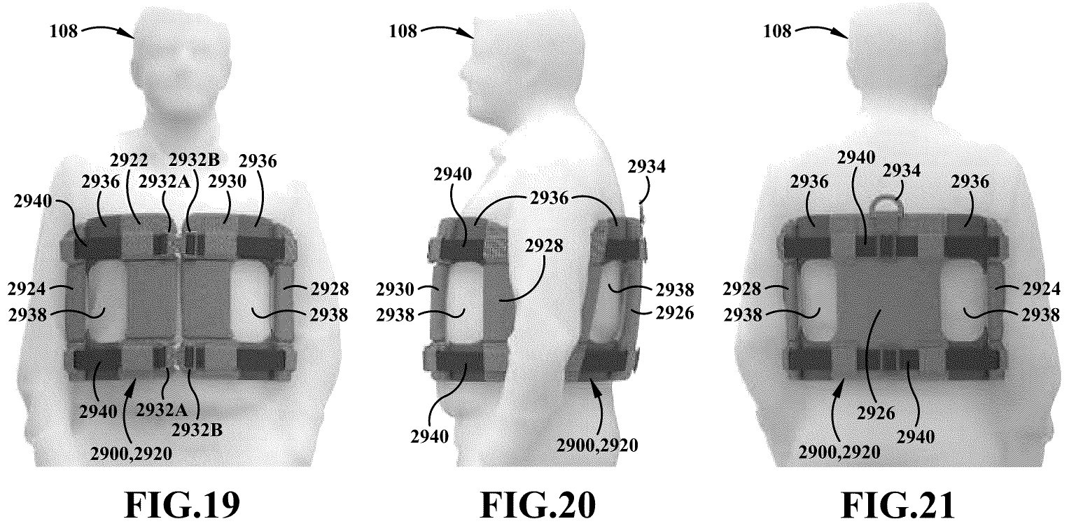

FIGS. 16-21 depict the harness system 2900. Referring now to FIG. 16, a top plan view of the harness system 2900. Harness 2920 may be generally rectangular in shaped, with a top section, a bottom section, an interior section and an exterior section. As shown in FIG. 16, a top plan view, there is a first panel 2922, second panel 2924, third panel 2926, fourth panel 2928, and fifth panel 2930. Harness 2920 may further include connectors 2932A and 2932B where connector 2932A is located on the first panel 2922 and the second connector 2932B is located on the fifth panel 2930. There may also be a hook or loop 2934, where the hook or loop 2934 may be located on the third panel 2926, which is also centered on the harness 2920. The harness 2920 may also include spacing elements or spacers 2936. In some embodiments, the spacers 2936 may be elastic to enable the harness 2920 to stretch in order to fit various sized individuals. Turning to FIG. 17, showing the interior of the harness 2920 which may include openings 2938 that are defined in the elastic spacers 2936 and between portions of adjacent panels 2922, 2924, 2926, 2928, and 2930. FIG. 18 depicts the exterior of the harness 2920 where the connectors 2932A and 2932B are connected by belts 2940. The belts 2940 may be adjusted to make the harness 2920 tighter or looser depending on the user. FIGS. 19-21 depict the harness 2920 on the user 108. FIG. 19 shows a front operational view of the harness 2920 showing that panels 2922 and 2930 connect by connectors 2932A and 2932B. FIG. 20 depicts a side operational view of the harness 2920 depicting that the side panel 2928 is located under the arm of the user while panels 2922 and 2930 are located on the front of the user. FIG. 21 depicts a rear operational view of the user wearing the harness 2920 where the panel 2926 is located on the users back. The hook 2934 may be placed on the users back side so that the connector 2616 connects to the users back side so that the tether system 2600 is behind them.

It is to be appreciated that in other embodiments, many designs (form factors) may supply varying degrees of integration between one or more portions.

It is to be understood that any of the embodiments may be interchanged with one another, meaning parts from the second embodiment may work with the first embodiment and parts from the first embodiment may work with the second embodiment. The first embodiment 200 and the second embodiment 2000 may be interchangeable as one skilled in the art would understand them to be.

The apparatus, subsystems, or system of the present disclosure may additionally include one or more sensors to sense or gather data pertaining to the surrounding environment or operation of the apparatus, subsystems, or system. Some exemplary sensors capable of being electronically coupled with the apparatus, subsystems, or system of the present disclosure (either directly connected to the apparatus, subsystems, or system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; global positioning sensors sensing location, elevation, distance traveled, velocity/speed; audio sensors sensing local environmental sound levels, or voice detection; photo/light sensors sensing ambient light intensity, ambient, day/night, UV exposure; TV/IR sensors sensing light wavelength; temperature sensors sensing machine or motor temperature, ambient air temperature, and environmental temperature; radar sensors; lidar sensors; ultrasonic sensors; magnetic sensors, image sensors; and moisture sensors sensing surrounding moisture levels.

It is to be appreciated that while a device, assembly, or system of the present disclosure my provide safety in traversing stairs, and alleviate tension associated with potential falls, alerts may be desired for one or more falls for which the device, assembly, or system was activated by a force exceeding an upper threshold (for example, WU). Sensors may be configured in a device, assembly, or system that can send an alert. It is contemplated that an alert can be sent to an authorized recipient (like an adult child) indicating a use of the system that included an instance that force exceeded an upper threshold. The authorized recipient may then check on the user.

The device, assembly, or system of the present disclosure may include wireless communication logic coupled to sensors on the device, assembly, or system. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

In another example, a point-to-point communication protocol like MiWi or ZigBee® is used. One or more of the device, assembly, or system of the present disclosure may serve as a repeater, or the devices, assemblies, or systems of the present disclosure may be connected together in a mesh network to relay signals from one device, assembly, or system to the next. However, the individual device, assembly, or system in this scheme typically would not have IP addresses of their own. Instead, one or more of the devices, assemblies, or system of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system that receives and processes signals from the device, assembly, or system of the present disclosure may differ from embodiment to embodiment. In one embodiment, alerts and signals from the device, assembly, or system of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a family member to indicate the state of the system or an indication of a falling event (i.e., send alert to the adult child of the elderly person using the device in their home). Thus, if a particular device, assembly, or system of the present disclosure creates an alert because of a data point gathered by one or more sensors, that alert can be sent, in e-mail or SMS form, directly to the individual responsible for fixing it. Of course, e-mail and SMS are only two examples of communication methods that may be used; in other embodiments, different forms of communication may be used.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A system for assisting the traversal of stairs in a residential environment, the system comprising:
a mount that is connected to at least one of a ceiling and a vertical wall in the residential environment;
a rail that is connected to the mount;
a trolley operably connected to the rail, wherein the trolly moves along the rail in response to stair traversing movement, and wherein the trolley comprises a brake;
a tether extending downward from the trolley;
a harness connected to the tether, wherein the harness is donned during the stair traversing movement;
wherein the brake is activated in response a force exerted on the tether that exceeds a maximum threshold and corresponds to a user falling after the harness has been donned; and
a de-slack subsystem operably connected to the tether to remove slack in the tether during the stair traversing movement.

2. The system of claim 1, wherein the de-slack subsystem further comprises at least one reel that releases and retracts the tether.

3. The system of claim 1, wherein the de-slack subsystem further comprises two reels located along the tether between the harness and the trolley, wherein at least one of the two reels releases and retracts a portion of the tether.

4. The system of claim 1, wherein the de-slack system retracts the tether when the user traverses the stairs towards a top end of the stairs, and wherein the de-slack system releases the tether when the user traverses the stairs towards a bottom end of the stairs.

5. The system of claim 1, wherein the rail is composed of multiple rail sections connected end-to-end, wherein each rail section is four feet or less in length, which is adapted to facilitate ease of installation in the residential environment.

6. The system of claim 1, wherein the mount comprises:
an L-shaped member having a vertical first leg and a horizontal second leg, wherein the vertical first leg is fixedly connected to the vertical wall in the residential environment below the ceiling.

7. The system of claim 6, wherein the mount further comprises:
a terminal free end of the horizontal second leg the L-shaped member, wherein the rail is connected to the terminal free end of the horizontal second leg.

8. The system of claim 6, wherein the mount further comprises:
a cross brace extending between the vertical first leg and the horizontal second leg.

9. The system of claim 1, wherein the harness comprises:
a connector located near the center of the harness, wherein the connector is a hook or loop that is connected to a connection point on the tether.

10. The system of claim 1, wherein the harness comprises:
a first panel, a second panel, a third panel, a fourth panel, and a fifth panel, wherein the first panel, second panel, third panel, fourth panel, and fifth panel are connected, respectively, by spacer elements.

11. The system of claim 10, further comprising:
a belt on the harness that extends from a first connector coupled to a first end of the belt to a second connector coupled to a second end of the belt;
wherein the belt extends across the first panel, the second panel, the third panel, the fourth panel, and the fifth panel and the respective spacer elements, and wherein the belt is adjustable to vary a circumference of the harness when the first connector and the second connector are connected together.

12. The system of claim 1, further comprising:
a first portion of the tether that is attached to the trolley;
a second portion of the tether that is free from the trolley;
a handle at the second portion of the tether, wherein the handle is configured to be grasped by the user while traversing the stairs.

13. The system of claim 1, further comprising:
wheels on the trolley that remain in a stationary first position until a sufficient force is applied to the harness or tether that exceeds a minimum threshold indicative of the user having donned the harness to thereby prevent trolley movement when the system is not in use, and wherein the wheels of the trolley are permitted to roll when the force applied exceeds the minimum threshold to thereby enable the trolley to move to a second position along the rail.

14. A method of traversing stairs in a residential environment comprising:
donning a harness connected to a tether that extends downward from a trolley that is moveable along a rail mounted to one of a wall and a ceiling above stairs in a residential environment;
traversing the stairs;
retracting slack in the tether with a de-slack subsystem comprising at least one reel coupled to the tether in response traversing the stairs; and
applying a brake to stop movement of the trolley in response to an exerted force that exceeds a maximum threshold, wherein the maximum threshold is associated with a user having fallen while traversing the stairs.

15. The method of claim 14, further comprising:
enabling the trolley to move along the rail in response to donning the harness by applying a force that exceeds a minimum threshold, wherein the trolley remains stationary until the force exceeds the minimum threshold.

16. The method of claim 14, further comprising:
lengthening the tether of the de-slack system between the harness and the at least one reel by unspooling the reel when traversing down the stairs.

17. The method of claim 14, further comprising:
shortening the tether of the de-slack system between the harness and the at least one reel by unspooling the reel when traversing up the stairs.

18. The method of claim 14, further comprising:
holding on to a handle located at a free end of the tether while traversing the stairs, wherein the handle is free from the harness; and
using the handle as support while traversing the stairs.

19. The method of claim 14, further comprising:
moving the trolley along the rail that is connected to a mount comprised of an L-shaped member, wherein the L-shaped member includes a vertical first leg and a horizontal second leg, wherein the vertical first leg is fixedly connected to the vertical wall in the residential environment below the ceiling

20. The method of claim 14, further comprising:
moving the trolley along the rail that is composed of multiple rail sections connected end-to-end, wherein each rail section is four feet or less in length, which is adapted to facilitate ease of installation in the residential environment.
